(19) United States
(12) Patent Application Publication
(10) Pub. No.: US 2011/0085451 A1
(43) Pub. Date: Apr. 14, 2011

(54) TESTING DEVICE AND TESTING METHOD

(75) Inventor: Koji TAKAHARA, Kawasaki (JP)

(73) Assignee: FUJITSU LIMITED, Kawasaki (JP)

(21) Appl. No.: 12/968,883

(22) Filed: Dec. 15, 2010

Related U.S. Application Data
(63) Continuation of application No. PCT/JP2008/061570, filed on Jun. 25, 2008.

(51) Int. Cl. H04L 12/26; G06F 15/173

(52) U.S. Cl. 370/249; 709/224

(57) ABSTRACT

A testing device connected to at least one network adaptor, including: a transmission application unit to give an instruction of transmitting data to a virtual address defined as a destination address; an address translation unit to translate, if a test mode is set up, the destination address of the data into an address allocated to the network adaptor connected to the testing device, send the data to the network adaptor or another network adaptor connected to said the testing device and get the network adaptor or the another network adaptor to transmit the data; a reception application unit to receive the data via the network adaptor to which the translated destination address is allocated; and a calculation unit to calculate a test result based on a transmission result of the data.

### CROSS-REFERENCE TO RELATED APPLICATIONS

This is a continuation of Application, filed under U.S.C. §111(a) of international Application PCT/JP2008/061570, filed on Jun. 25, 2008, the contents of which are herein wholly incorporated by reference.

### FIELD

The present invention relates to a technology of testing a network adaptor (communication control unit) and a network driver.

### BACKGROUND

The network adaptor is mounted or implemented in a computer and is used for communications between the computers. A majority of network adaptors take a card-like configuration for insertion into an extension slot of the computer and therefore referred to as network cards, network boards, network interface cards, etc. A test of the network adaptor is exemplified such as a high-load test and measurement of performance.

The high-load test of the network adaptor connotes a test for causing the network adaptor to transmit or receive data having the largest possible byte count or data of the largest possible number of packets.

The measurement of performance of the network adaptor connotes, when causing the network adaptor to transmit or receive the data having the largest possible byte count or the data of the largest possible number of packets, calculating and thus obtaining a quantity of the data flows per unit time.

When measuring the performance, the data is transmitted and received at the highest possible speed, and therefore the performance measurement becomes the high-load test.

There is, however, a case in which a capability of the network adaptor is not necessarily utilized at the maximum in one TCP connection, so that the high-load test often adopts a technique of starting up a plurality of performance measurement tools simultaneously or bidirectionally.

Further, for instance, a technology disclosed in the following Patent document 1 is given by way of the prior art related to the invention of the present application.
[Patent document 1]
Japanese Laid-Open Patent Publication No. H08-335198
[Patent document 2]
Japanese Laid-Open Patent Publication No. H04-027239
[Patent document 3]
Japanese Laid-Open Patent Publication No. H06-309251
[Patent document 4]
Japanese Laid-Open Patent Publication No. H04-172843

The performance measurement and the high-load test are, as illustrated in FIG. 53, conducted by performing TCP/IP-based (Transmission Control Protocol/Internet Protocol based) communications in a way that connects two computers provided with network adaptors to a network cable and uses existing application software such as “netperf”.

The computer is generally expensive, and hence, if the two machines (computers) are requested each time the high-load test and the performance measurement are carried out, a cost expended therefor increases.

Further, a large proportion of computers of recent types each include a plurality of CPUs (Central Processing Units) and has a high throughput because of the CPU being speeded up and a memory capacity rising up to 1 GB or more, and consequently it is highly futile to occupy the two computers for testing the network adaptor.

For example, as illustrated in FIG. 54, even when inserting the two network adaptors into the single machine and thus performing the communications between these network adaptors, there is a small possibility that the throughput becomes deficient.

However, the computer is not deficient in its throughput, and nevertheless neither the high-load test nor the performance measurement can be conducted with the single-computer-based configuration as depicted in FIG. 54 for the following reasons.

(1) When performing the communications via the IP layer, it follows that the packet loops back at the IP layer due to the single computer, and the data does not flow to the network adaptor.

For example, as illustrated in FIG. 53, in the case of carrying out the communications between the two computers (hosts), the packet sent from application software 91A in a host HA is transmitted to a network adaptor 96A via a stream head 92A, a TCP layer 93A, an IP layer 94A and a driver 95A.

Then, the network adaptor 96A in the host HA transmits the packet to a network adaptor 96B in a host HB via a network cable.

In the host HB, the packet received by the network adaptor 96B is transmitted to application software 91B via a driver 95B, an IP layer 94B, a TCP layer 93B and stream head 92B.

In contrast with this, as depicted in FIG. 54, in the case of performing the communications between the network adaptors 96A and 96B mounted in the single computer, the packet sent from the application software 91 is transmitted to the IP layer 94 via the stream head 92 and the TCP layer 93. Then, the packet loops back at the IP layer 94 and thus returns to the application software 91 via the TCP layer 93 and the stream head 92.

Namely, in the host HA, when transmitting the packet addressed to the IP address of the network adaptor 96A or the network adaptor 96B mounted in the same host HA, the source IP address becomes identical with the destination IP address, with the result that the packet loops back at the IP layer 94 but flows to neither the network driver nor the network adaptor.

In the example of FIG. 55, an IP address “10.20.1.1” is allocated to the network adaptor 96A, while an IP address “10.20.2.1” is allocated to the network adaptor 96B.

Then, in the case of transmitting the packet to the network adaptor 96B by use of “netperf” as application software, an input is done as follows.

>netperf -H 10.20.2.1

In this case, the packet is not transmitted to the network adaptor 96B with the network adaptor 96A serving as a sender but has consequently the same address as the destination IP address because of the IP layer 94 selecting the IP address of the network adaptor 96B as a source IP address (sender).

Such a reason derives from an IP transmission rule being defined as follows.

(1-1) The source IP address, if the network adaptors 96A, 96B belonging to the same IP subnet as that of the destination IP address are mounted in that host, becomes the IP address of the network adaptor belonging to this IP subnet. In the case of the example in FIG. 55, the destination IP address is “10.20.2.1”, and therefore the source IP address is also“10.20.2.1”.

(1-2) If the destination IP address exists within the same host, a scheme is not that the packet is not transferred to the low-order driver but that the data (packet) loops back at the IP layer and is thus transferred to the host (high-order element).

(2) If transmitted and received from the user space without utilizing the IP (Internet Protocol), a packet loss occurs frequently.

If a protocol such as “ioctl” (I/O control) other than the IP is used, the packet can be transmitted to the driver via the stream head but through neither the TCP layer nor the IP layer from the user space and can be received from the driver via the network adaptor.

The stream head 92 and the driver 95 do not often, however, implement a function of queuing the data, and hence, if a certain reception packet is in the midst of being processed by the stream head, there are many cases in which the driver does not transmit the next packet to the stream head but gets the packet lost.

(2-1) Reason for Losing Packet When Received

Generally, at a high-load transmission and reception, a transmission and reception packet interval, after a continuation of several relatively-short time intervals, becomes a relatively-long time interval in many cases.

Supposing that a packet 1, a packet 2, a packet 3, . . . are received in this sequence, it happens that the interval between the respective packets ranging from the packet 1 up to the packet 10 is on the order of 10 μs (microseconds); the interval between the packet 10 and the packet 11 is 100 μs; the interval between the respective packets ranging from the packet 11 up to the packet 20 is 10 μs; and the interval between the packet 20 and the packet 21 is 100 μs. (*1)

On the other hand, a period of time expended for transferring one block of data to the user space from the kernel space is an intermediate length of time (e.g., 15 μs) therebetween in many cases.

In this case, a certain packet reaches the stream head and a period of 10 μs elapses, the stream head does not yet hand over the packet to the user space. Therefore, the driver determines that the stream head is still in the midst of processing the packet, and discards the next packet (gets the packet lost).

Note that the reason why the time-intervals (*1) given above are set up lies in the following two points.

(2-1-1) A CPU assignment of the host (computer) is conducted based on TSS (Time Sharing System). The CPU is once assigned on the packet transmitting side, then the plurality of packets is consecutively transmitted during the period the CPU is assigned on the packet transmitting side, however, the transmission is interrupted somewhere at a time because of TSS. Thereafter, the CPU is again assigned to resume the transmission, and the plurality of packets is consecutively transmitted, however, there might be a case in which the time is requested for this transmission.

(2-1-2) If the queue of the hardware is full of the packets, the driver waits for the transmission, however, in the majority of cases, a completion-of-transmission notification is given only once for dozens of packets in order to avoid increasing a CPU activity ratio due to the notifying process (interrupt). Therefore, it follows that the driver, after executing the process of transmitting the dozens of packets at a short time-interval, performs such an operation as to wait for the completion-of-transmission notification from the hardware for a relatively long period of time.

On the other hand, the use of TCP/IP does not cause the packet loss owing to the following framework.

The stream head is in the midst of processing the packet, in which case the TCP layer 93 does not discard the packet but stands by.

The IP layer 94, if the TCP layer 93 is in the standby status or if the data is already accumulated in the queue of the IP layer 94, registers the data in the queue.

The IP layer 94, upon canceling the standby status of the TCP layer 93, transfers the data to the TCP layer 93.

Thus, even if the packets are accumulated, the queuing makes the packets stand by, thereby preventing the packets from being lost.

Note that if the queuing is executed in the same way as by the TCP/IP and if such a communication protocol is newly generated that the packet, of which the destination IP address exists within the self-device, does not loop back anterior to the driver, the problem described above can be also avoided. In the network such as the Internet and the Intranet, however, the TCP/IP is the de facto standard, and therefore, if using a protocol other than the TCP/IP, such a problem arises that a test conforming to the real situation is not performed.

Moreover, as illustrated in FIG. 56, there is a network adaptor having an intra-adaptor loopback function of inserting one piece of network adaptor into the single machine and receiving the transmitted packet by the adaptor itself.

This method enables the adaptor and the driver to be tested by the single host device (computer) and one piece of adaptor without any cable.

However, the TCP/IP is not used for the reason (1) given above, and consequently the problem (2) arises.

### SUMMARY

According to an aspect of the invention, an A testing device connected to at least one network adaptor, including: a transmission application unit to give an instruction of transmitting data to a virtual address defined as a destination address; an address translation unit to translate, if a test mode is set up, the destination address of the data into an address allocated to the network adaptor connected to the testing device, send the data to the network adaptor or another network adaptor connected to said the testing device and get the network adaptor or the another network adaptor to transmit the data; a reception application unit to receive the data via the network adaptor to which the translated destination address is allocated; and a calculation unit to calculate a test result based on a transmission result of the data.

Further, the present invention may also be a program making a computer execute the testing method described above. Still further, the present invention may also be a computer readable recording medium recorded with this program.

The function thereof can be provided by making the computer read and execute the program recorded on this recording medium.

Herein, the computer readable recording medium connotes a recording medium capable of storing information such as data and programs electrically, magnetically, optically, mechanically or by chemical action, which can be read from the computer.

Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

The object and advantage of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a function block diagram of a testing device in a first embodiment;

FIG. 2 is a diagram of a hardware configuration of the testing device;

FIG. 3 is a conceptual diagram of a testing method;

FIG. 4 is an explanatory diagram of the testing method;

FIG. 5 is a diagram illustrating communication procedures from an adaptor 17A to an adaptor 17B;

FIG. 6 is a diagram illustrating the communication procedures from the adaptor 17A to the adaptor 17B;

FIG. 7 is an explanatory diagram of a process of transmitting a packet in a way that translates an address;

FIG. 8 is an explanatory diagram of the process of transmitting the packet in a way that translates the address;

FIG. 9 is an explanatory diagram of the process of transmitting the packet in a way that translates the address;

FIG. 10 is an explanatory diagram of the process of transmitting the packet in a way that translates the address;

FIG. 11 is an explanatory diagram of the process of transmitting the packet in a way that translates the address;

FIG. 12 is an explanatory diagram of the process of transmitting the packet in a way that translates the address;

FIG. 13 is a diagram illustrating an example of the address translation;

FIG. 14 is a diagram illustrating an example of the address translation;

FIG. 15 is a diagram illustrating an example of the address translation;

FIG. 16 is a diagram illustrating an example of the address translation;

FIG. 17 is a diagram illustrating an example of the address translation;

FIG. 18 is a diagram illustrating an example of the address translation;

FIG. 19 is a diagram illustrating a transmission route when in a test mode;

FIG. 20 is a diagram illustrating the transmission route when in the test mode;

FIG. 21 is an explanatory diagram of an address translation register;

FIG. 22 is an explanatory diagram illustrating a process of updating the address translation register;

FIG. 23 is a diagram illustrating one example of values written to the address translation register;

FIG. 24 is a diagram illustrating one example of the values written to the address translation register;

FIG. 25 is a diagram illustrating an example of setting a normal mode by clearing the values in the address translation register;

FIG. 26 is an explanatory diagram of the process of updating address translation information;

FIG. 27 is a function block diagram of the adaptor when in the normal mode;

FIG. 28 is a function block diagram of the adaptor when in the test mode;

FIG. 29 is a function block diagram of a test converter.

FIG. 30 is an explanatory diagram of an address translation process;

FIG. 31 is an explanatory diagram of the address translation process;

FIG. 32 is a diagram illustrating a format of the packet attached with a MAC header;

FIG. 33 is an explanatory diagram of the MAC header;

FIG. 34 is a diagram illustrating a format of an ARP packet;

FIG. 35 is an explanatory diagram of the ARP packet;

FIG. 36 is a diagram illustrating a format of an IP header;

FIG. 37 is an explanatory diagram of the IP header;

FIG. 38 is a diagram illustrating a format of a TCP header;

FIG. 39 is an explanatory diagram of the TCP header;

FIG. 40 is an explanatory diagram of a transmission process of a driver unit;

FIG. 41 is a function block diagram of the testing device in a second embodiment;

FIG. 42 is a conceptual diagram of a testing method;

FIG. 43 is a diagram illustrating an example of the address translation;

FIG. 44 is a diagram illustrating an example of the address translation;

FIG. 45 is a diagram illustrating an example of the address translation;

FIG. 46 is a diagram illustrating a transmission route when in the test mode;

FIG. 47 is an explanatory diagram of the address translation register;

FIG. 48 is an explanatory diagram of the process of updating the address translation register;

FIG. 49 is a diagram illustrating one example of the values written to the address translation register;

FIG. 50 is a diagram illustrating an example of setting the normal mode by clearing the values in the address translation register;

FIG. 51 is a function block diagram of the adaptor when in the normal mode;

FIG. 52 is a function block diagram of the adaptor when in the test mode;

FIG. 53 is a schematic diagram of a conventional testing device;

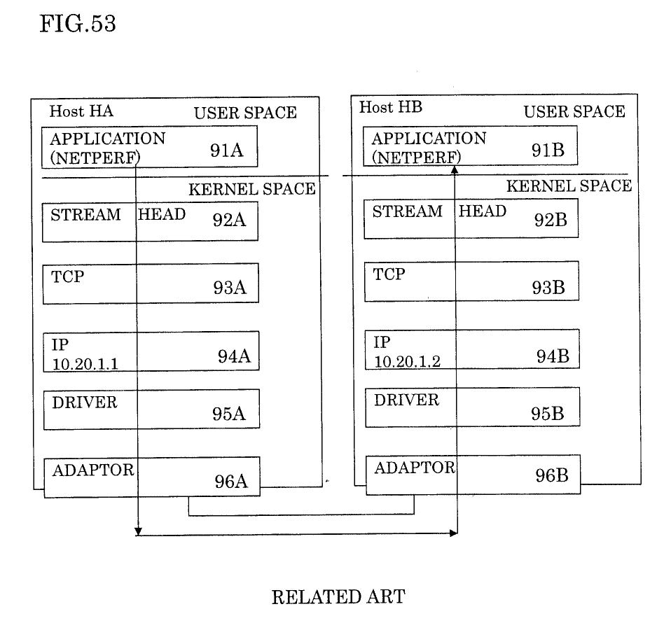

FIG. 54 is a diagram illustrating an example in which one adaptor is mounted in the single testing device;

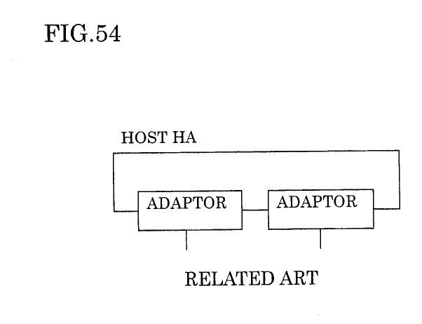

FIG. 55 is a diagram illustrating a processing flow in a case where two adaptors are mounted in the single testing device;

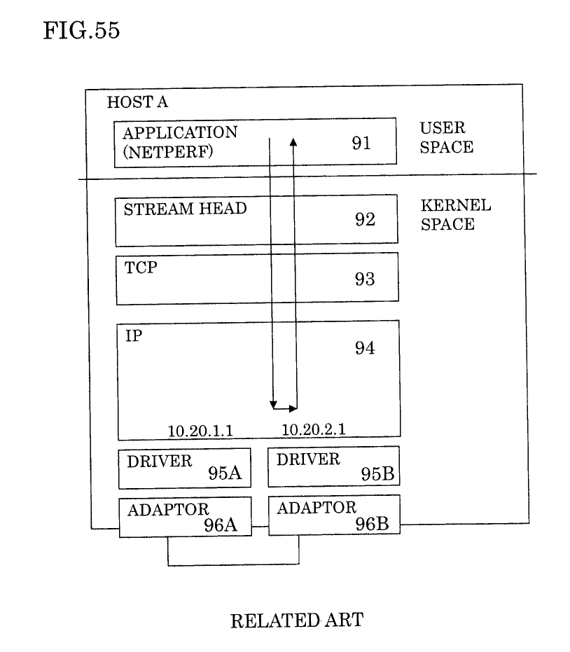

FIG. 56 is a diagram illustrating a processing flow in a case where one adaptor is mounted in the single testing device.

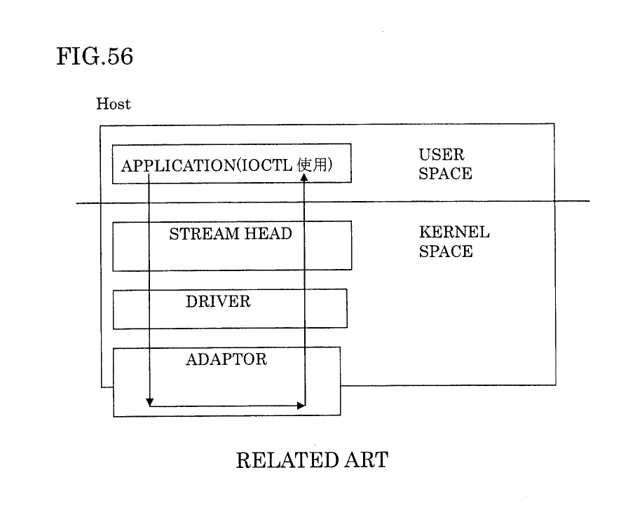

### DESCRIPTION OF EMBODIMENTS

Preferred embodiments of the present invention will be explained with reference to accompanying drawings.

<Outline of Configuration>

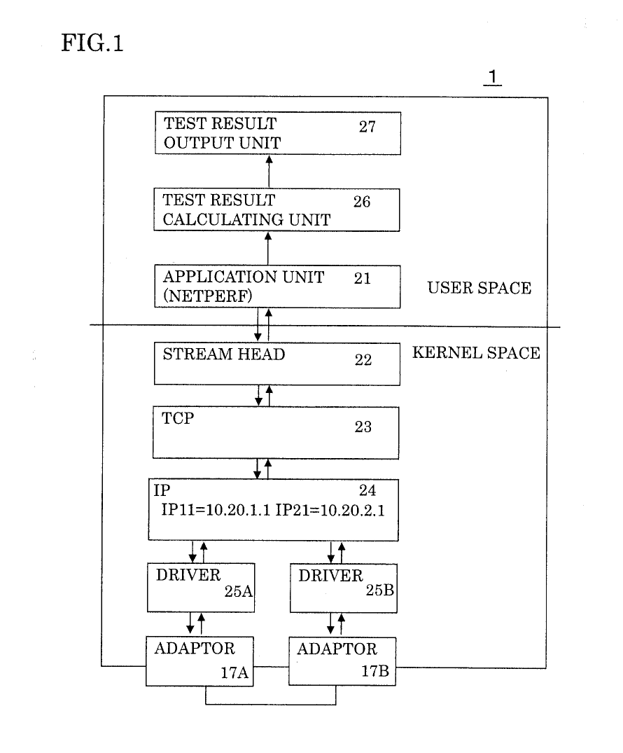

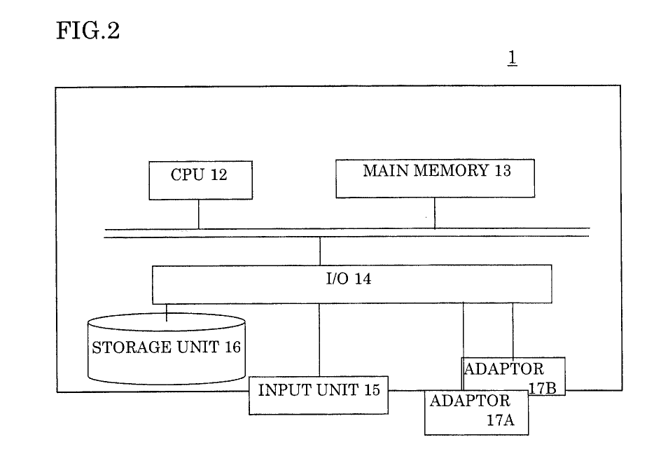

FIG. 1 is a function block diagram illustrating, and FIG. 2 is a diagram of a hardware configuration of a testing device according to the present embodiment.

As illustrated in FIG. 2, a testing device 1 is a general type of computer including a CPU (Central Processing Unit) 12, a main memory 13, an input/output (I/O) port 14, etc. within a main body 11.

Connected to the I/O port 14 are an input unit 15 such as a keyboard and a mouse for inputting a user's instruction, a storage unit 16 such as a hard disk stored with data and software for arithmetic processes, and network adaptors 17A, 17B each functioning as a communication control unit which controls communications with other computers.

The storage unit 16 is preinstalled with an operating system (OS), application software such as “Netperf”, and a network driver.

The CPU 12 properly reads the OS, the application program and the network driver from the storage unit 16 via the main memory 13, then executes these pieces of software, and arithmetically processes the information read from the network adaptor (which will hereinafter be simply termed the adaptor) 17 and the storage unit 16, thereby functioning as an application unit 21, a stream head 22, a TCP (Transmission Control Protocol) unit (TCP layer) 23, an IP (Internet Protocol) unit (IP layer) 24, driver units (drive control units) 25A, 25B, a test result calculating unit 26 and a test result output unit 27 as illustrated in FIG. 1. Note that a kernel space is defined as a memory area ensured by the OS for operations of the kernel and the device driver, and the user space is defined as a memory area ensured by the OS for an operation of a user process.

The application unit 21 has a transmission application unit and a reception application unit.

In the case of functioning as the transmission application unit, the CPU 12 transmits, to the stream head 22, a maximum quantity of packets which the adaptors 17A, 17B can transmit or transmits packets at a highest transmissible speed which the adaptors 17A, 17B can transmit in order to test the adaptors 17A, 17B and the network driver.

Further, the CPU 12 functioning as the reception application unit receives the packets, which have been received by the adaptors 17A, 17B, via the driver units 25A, 25B corresponding to the adaptors receiving the packets, the IP layer 24, the TCP layer 23, and the stream head 22.

The CPU 12 functioning as the test result calculating unit 26 measures a quantity of transmitted packets, a packet transmitting speed, a quantity of the received packets, a packet receiving speed, and an error count, and thus calculates values of a transmitting speed per unit time and an error rate as test results.

The CPU 12 functioning as the rest result output unit 27 executes a process of outputting the thus-calculated test results such as recording the results on a recording medium, displaying the results on a display unit, printing the results, and transmitting the results to other computers.

The CPU 12 functioning as the stream head 22 executes a process of transferring and receiving the data (packets) between the user space and the kernel space.

The CPU 12 functioning as the TCP layer 23 generates a packet (TCP segment) in a way that attaches a TCP header to the transmission-target data coming from the stream head 22, and transfers the thus-generated packet to the IP layer 24. Further, the CPU 12 functioning as the TCP layer 23 executes a TCP (Transmission Control Protocol)-based process such as detaching the TCP header from the packet received from the IP layer 24 and transferring the packet to the stream head 22.

The CPU 12 functioning as the IP layer 24 generates a packet (IP datagram) in a way that attaches an IP header to the transmission-target packet coming from the TCP layer 23, and transfers the thus-generated packet to the driver units 25A, 25B. Moreover, the CPU 12 functioning as the IP layer 24 executes an IP (Internet Protocol)-based process such as detaching the IP header from the packet received from any one of the drivers and transferring the packet to the TCP layer 23. Further, the IP layer 24 selects, when transmitting the packet, the adaptor 17A or 17B belonging to the same subnet as specified by a destination address and transfers the packet to the driver unit 25A or 25B corresponding to the selected adaptor, thus getting the packet transmitted. The packet generating unit in the present generates the packet by attaching the destination address to the data according to the Internet Protocol, and includes the TCP layer 23 and the IP layer 24. The IP layer 24 in the present embodiment allocates an address IP11=10.20.1.1 to the driver 25A and the adaptor 17A and an address IP21=10.20.2.1 to the driver 25B and the adaptor 17B.

The CPU 12 functioning as the driver units 25A, 25B executes a process of transferring the data (e.g., the packet) coming from the side of the computer 1 to the adaptors 17A, 17B corresponding to the respective driver units and getting the data transmitted. Furthermore, the CPU 12 functioning as the driver units 25A, 25B executes a process of handing over, to the IP layer 24, the packets received by the adaptors 17A, 17B corresponding to the respective driver units.

The adaptors 17A, 17B send the data received from the driver units 25A, 25B corresponding to these adaptors to the network such as the Internet and transfer the data received via the network to the driver units 25A, 25B corresponding to the respective adaptors, thereby enabling the communications with other computers to be performed.

In the computer according to the present embodiment, the driver units 25A, 25B or the adaptors 17A, 17B have an address translation unit. Namely, the CPU 12 functioning as the driver units 25A, 25B, the processing units of the adaptors 17A, 17B and some of the circuits realize the function of the address translation unit.

The address translation unit, in the case of selecting a test mode defined as a mode of testing the driver or the adaptor, translates the destination address of the data into an address allocated to the network adaptor connected to the self-device, then sends the data to another network adaptor connected to the network adaptor concerned or the self-device, and gets the data transmitted.

In the computer 1 according to the present embodiment, in the case of performing test communications as the communications for the test between the two adaptors provided in the self-device, the user or the application unit 21 designates an IP address of a virtual machine as a destination IP address. With this scheme, the data transmission destination is not set within the self-device, with the result that the packet sent by the application unit 21 is not looped back at the IP layer 24 but is transmitted to, e.g., the driver unit 25A from the IP layer 24.

Then, in the computer 1, the adaptor 17A or the driver 25A across the IP layer 24 translates the destination address of the packet into the IP address of another adaptor 17B installed within the self-device. This address translation enables the test communications to be performed, in which the packet is transmitted from the adaptor 17A and received by the adaptor 17B within the self-device via a network cable.

Herein, the computer 1 translates the destination IP address into the IP address within the self-device and translates a source IP address into an address on the virtual machine by use of the adaptor 17A or the driver 25A, and thus transmits the packet. With this transmission, the application unit 21 receiving the packet recognizes this traffic as the communication from the virtual machine and gives a response to the virtual machine. Note that the test communications to the adaptor 17B from the adaptor 17A have been exemplified, however, the driver 25B or the adaptor 17B operates in the same way as the driver 25A or the adaptor 17A operates, thereby enabling the test communications to the adaptor 17A from the adaptor 17B to be conducted.

Namely, the computer 1 according to the present embodiment prevents the packet from being looped back at the IP layer 24 in a way that makes the IP layer 24 view as if the packet is transmitted to the virtual machine from one of the adaptors 17A, 17B within the self-device but actually transmits the packet to the other adaptor by translating the destination address. At this time, the computer 1 translates the source address of the packet into the address of the virtual machine, and therefore the other adaptor 17A or 17B receives this packet as the packet coming from the virtual machine with no contradiction.

This scheme enables the test to be performed by use of the TCP/IP between the two adaptors on one single testing device.

Moreover, the use of the TCP/IP therefore enables a high-load test and a performance measurement to be conducted without any occurrence of a packet loss.

### First Embodiment

—Case of Inserting Tow Cards into One Machine—

The following is description detail of an example of installing the two adaptors (network cards) 17A, 17B into the testing device 1 illustrated in FIGS. 1 and 2.

In the first embodiment, “10.20.1.1” is allocated as an IP address IP11 of the adaptor 17A, and “10.20.2.1” is allocated as an IP address IP21 of the adaptor 17B.

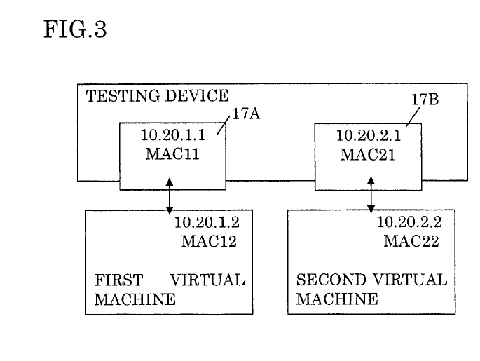

FIG. 3 is a conceptual diagram of a testing method in the first embodiment. As illustrated in FIG. 3, the communications are performed to make the IP layer 24 view as if the communication partner device of the adaptor 17A of which the IP address is “10.20.1.1” is a first virtual machine having an IP address “10.20.1.2”. Further, the communications are performed to make the IP layer 24 view as if the communication partner device of the adaptor 175 of which the IP address is “10.20.2.1” is a second virtual machine having an IP address “10.20.2.2”.

The IP addresses on the virtual machine are selected from within addresses that do not exist on the testing device 1. This is because if the IP address on the virtual machine exists on the testing device 1, when this IP address is set as the destination address, the packet is, it follows, looped back at the IP layer 24.

Moreover, the IP address belonging to the same IP subnet as the IP subnet of the adaptor 17A is allocated to the first virtual machine so that the packet is transmitted from the first adaptor 17A to the first virtual machine. Similarly, the IP address belonging to the same IP subnet as that the IP subnet of the adaptor 17B is allocated to the second virtual machine so that the packet is transmitted from the second adaptor 17B to the second virtual machine.

A MAC (Media Control Access) address on the virtual machine is different from addresses on the testing device 1 and other virtual machines. Namely, a MAC address MAC11 of the first virtual machine and a MAC address MAC21 of the second virtual machine are differentiated from a MAC address MAC12 of the adaptor 17A and a MAC address MAC22 of the adaptor 17B.

As described above, in order to make the IP layer view as if performing the communications with the virtual machine, the first embodiment adopts the testing method in which the communications are carried out while the hardware such as the adaptor or the driver translates the IP address and the MAC address.

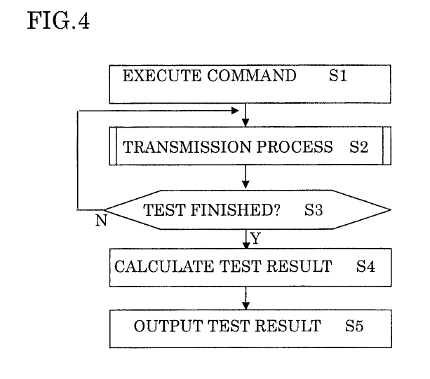

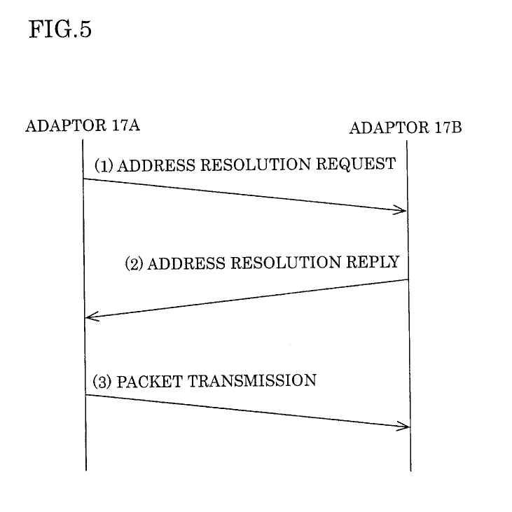

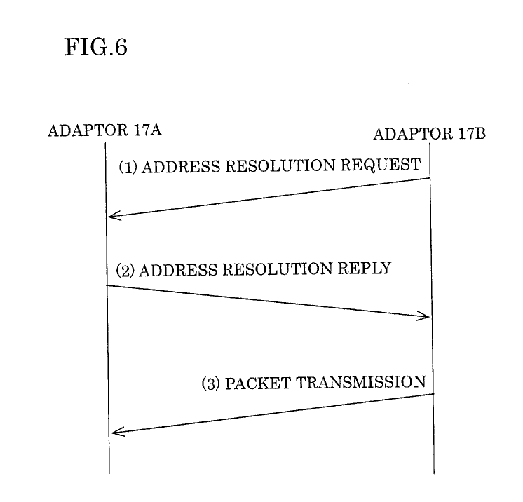

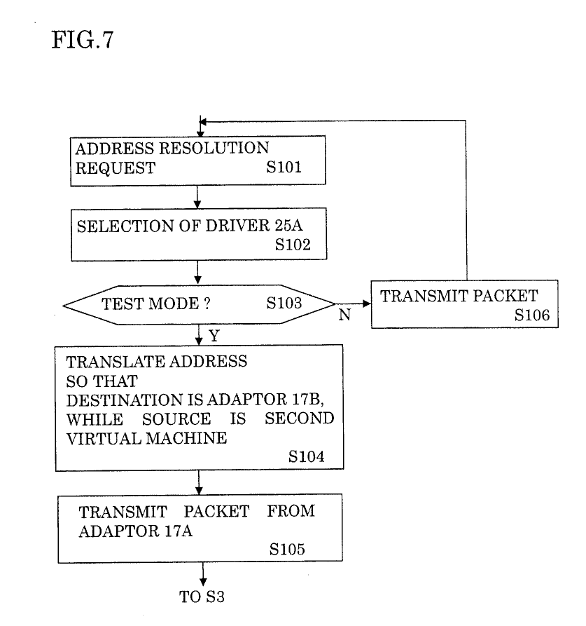

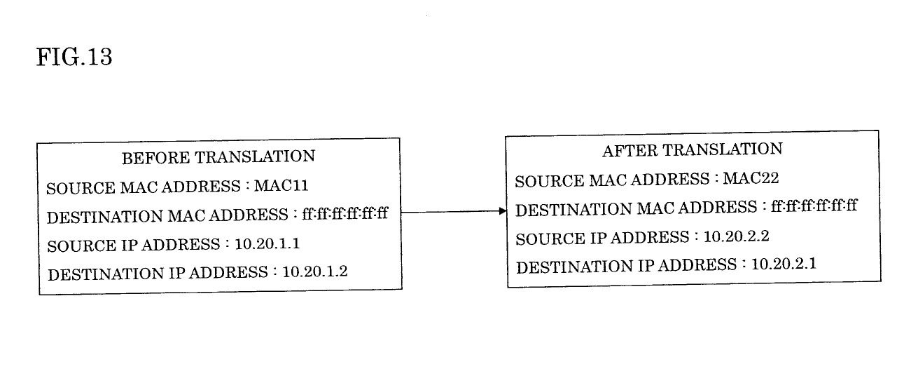

FIG. 4 is an explanatory flowchart of the testing method using the computer 1 in the first embodiment; FIG. 5 is a diagram illustrating procedures when starting the communication flowing to the adaptor 17B from the adaptor 17A; FIG. 6 is a diagram illustrating procedures when starting the communication flowing to the adaptor 17A from the adaptor 17B; FIGS. 7 through 12 are flowcharts illustrating the transmission process of FIG. 4 according to the procedures in FIGS. 5 and 6; and FIGS. 13 through 18 are explanatory diagrams of the addresses translated according to the procedures in FIGS. 7 through 12. When the user inputs an instruction of transitioning to the test mode, for example, “addrtrans -s”, which will be mentioned later on, as a command for transitioning to the test mode, the computer 1 sets the test mode. It is to be noted that when the user inputs the command of transitioning to the test mode, the IP address of the first virtual machine defined as the communication partner device of the adaptor 17A and the IP address of the second virtual machine defined as the communication partner device of the adaptor 17B are set as illustrated in FIG. 3 in the first embodiment. As for the address of the virtual machine, without being limited to the user's input, the computer 1 may automatically generate the address belonging to the same subnet as the IP addresses allocated to the adaptors 17A, 17B belong to. For example, the IP address of the adaptor 17A is incremented or decremented by a predetermined value within the same subnet, thereby generating the IP address of the first virtual machine.

Then, when the user inputs a transmission instruction, e.g., “netperf”, which will be mentioned later on, as a command for performing the test, the computer 1 starts the test by executing the command (S1), and executes the transmission process corresponding to the command (S2). To be specific, the computer 1 executes the following processes (1)-(6).

The discussion starts with explaining a case in which the communication flowing to the adaptor 17B from the adaptor 17A is designated by inputting the command for performing the test as illustrated in FIG. 5.

(1) In response to the command for performing the test, the application unit 21 is on the verge of starting the transmission of the packet addressed to the first virtual machine. Herein, the IP address of the first virtual machine is designated differently from the IP addresses of the adaptors within the self-device as described above. Therefore, the IP layer 24 makes, as illustrated in FIG. 7, an address resolution request for requesting the MAC address associated with the destination IP address (S101).

Then, the IP layer 24 selects the driver unit 25A belonging to the same IP subnet as that the IP subnet of a destination IP address of an address resolution request packet, and transmits the address resolution request packet to the driver unit 25A (S102).

The adaptor 17A or the driver unit 25A receiving the packet determines whether or not the set-up mode is an address translation mode (test mode) (S103). As a result of the determination, if the set-up mode is the address translation mode, as illustrated in FIG. 13, the destination IP address is translated into 10.20.2.1 from 10.20.1.2, the source IP address is translated into 10.20.2.2 from 10.20.1.1, and the source MAC address is translated into MAC22 from MAC11 (S104). Then, the adaptor 17A transmits the packet having the translated address to the outside (S105).

Note that if the set-up mode is determined not to be the address translation mode in S103, namely, if the communication not related to the testing command is indicated and a normal mode is set up, the adaptor 17A or the driver unit 25A transmits the packet without translating the address (S106).

Further, the address translation in S104 involves translating, as illustrated in FIG. 13, the destination address of the packet transmitted by the adaptor 17A or the driver unit 25A so that the transmission destination of the packet becomes the other adaptor 17B within the self-device. The example of FIG. 13, however, deals with the address resolution request packet, and hence the destination MAC address of this packet is set to ff.ff.ff.ff.ff.ff for broadcasting.

The address translation in S104 further involves translating, as illustrated in FIG. 13, the source IP address and the source MAC address of the packet to be transmitted so that the transmission source of the packet becomes the predetermined virtual machine. For example, the adaptor 17A, for making the communication partner device appear to be the second virtual machine from the adaptor 17B as illustrated in FIG. 3, transmits the packet in a way that translates the source IP address into 10.20.2.2 and the source MAC address into MAC22 of the packet to be transmitted in the example of FIG. 13.

The packet transmitted from the adaptor 17A is received by the adaptor 17B via the network cable. The adaptor 17B sends the received packet to the application unit 21 via the driver unit 25A, the IP layer 24, the TCP layer 23 and the stream head 22. Namely, the application unit 21 receives the packet as from the second virtual machine serving as the sender.

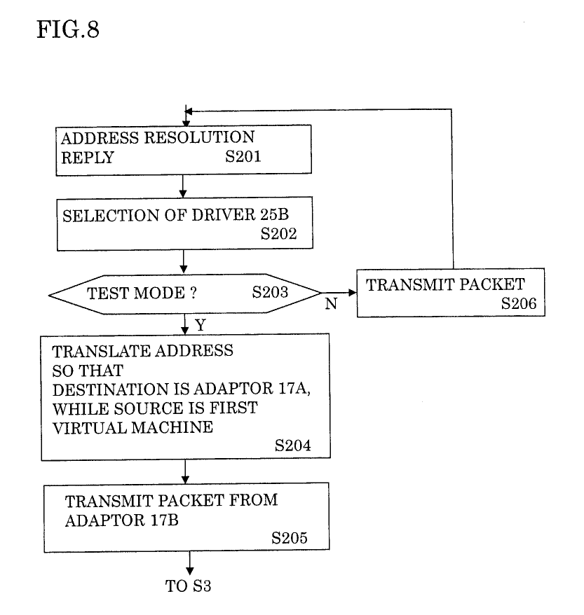

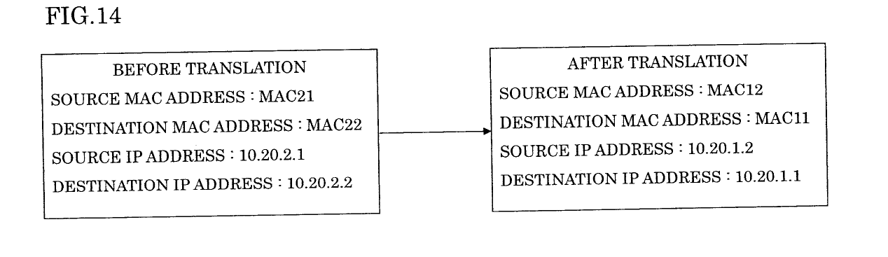

(2) The adaptor 17B or the driver unit 25B translates, when transmitting an address resolution reply (ARP (Address Resolution Protocol) reply), the MAC address and the IP address as illustrated in FIG. 14. An address translation process in the adaptor 17B or the driver unit 25B will hereinafter be described in detail with reference to FIG. 8.

Namely, the application unit 21 sends the address resolution reply back to the second virtual machine (S201).

In this case also, the destination IP address is the second virtual machine but is not within the self-device as illustrated in FIG. 3, and hence the IP layer 24 transmits the packet to the driver unit 25B belonging to the same IP subnet as that the IP subnet of the destination IP address (S202).

The adaptor 17B or the driver unit 25B receiving the packet from the IP layer 24 determines whether or not the set-up mode is the address translation mode (test mode) (S203). The adaptor 17B or the driver unit 25B translates, if the set-up mode is the address translation mode, as illustrated in FIG. 14, the destination IP address into 10.20.1.1 from 10.20.2.2, the destination MAC address into MAC11 from MAC22, the source IP address into 10.20.1.2 from 10.20.2.1, and the source MAC address into MAC12 from MAC21 (S204). Then, the adaptor 17B transmits the packet having the translated address to the outside (S205).

Note that if the set-up mode is determined not to be the address translation mode, namely, determined to be the normal mode in S203, the adaptor 17B or the driver unit 25B transmits the packet without translating the address (S206).

The address translation in S204 involves translating, as illustrated in FIG. 14, the destination IP address and the destination MAC address of the packet transmitted by the adaptor 17B or the driver unit 25B so that the transmission destination changes to the other adaptor 17A within the self-device from the second virtual machine.

The address translation in S204 further involves translating, as illustrated in FIG. 14, the source IP address and the source MAC address of the packet to be transmitted so that the transmission source changes to the first virtual machine from the adaptor 17B. As illustrated in FIG. 3, for making the communication partner device appear to be the first virtual machine from the adaptor 17A, in the example of FIG. 14, the source IP address is set to 10.20.1.2, and the source MAC address is set to MAC12.

The packet transmitted from the adaptor 17B is received by the adaptor 17A via the network cable. The adaptor 17A sends the received packet to the application unit 21 via the driver unit 25A, the IP layer 24, the TCP layer 23 and the stream head 22. Namely, the application unit 21 receives the packet as from the first virtual machine serving as the sender.

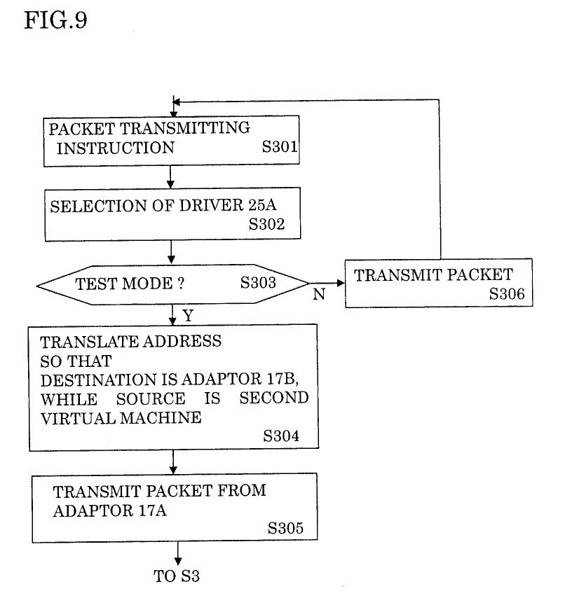

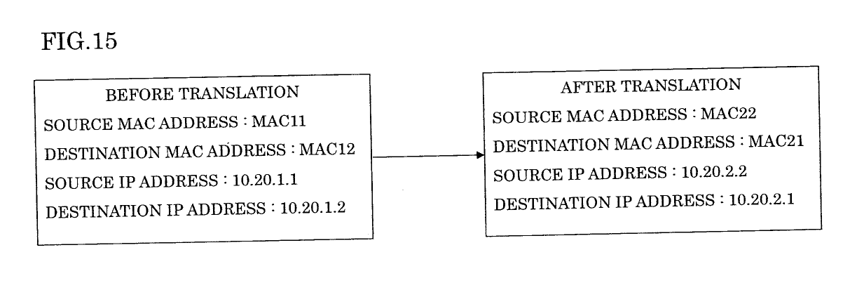

(3) The adaptor 17A or the driver unit 25A translates, when transmitting the TCP/IP packet, the MAC address and the IP address as illustrated in FIG. 15. An address translation process of the adaptor 17A or the driver unit 25A will hereinafter be described in detail with reference to FIG. 9.

The application unit 21, which recognizes the MAC address of the first virtual machine owing to the address resolution, transmits the packet addressed to the first virtual machine (S301).

The destination IP address is the first virtual machine but is not within the self-device as illustrated in FIG. 3, and hence the IP layer 24 transmits the packet to the driver unit 25A belonging to the same IP subnet as that the IP subnet of the destination IP address (S302).

The adaptor 17A or the driver unit 25A receiving the packet from the IP layer 24 determines whether or not the set-up mode is the address translation mode (test mode) (S303). If the set-up mode is the address translation mode, as illustrated in FIG. 15, the destination IP address is translated into 10.20.2.1 from 10.20.1.2, the destination MAC address is translated into MAC21 from MAC12, the source IP address is translated into 10.20.2.2 from 10.20.1.1, and the source MAC address is translated into MAC22 from MAC11 (S304). Then, the adaptor 17A transmits the packet having the translated address to the outside (S305). Note that if the set-up mode is determined not to be the address translation mode in S303, the packet is transmitted without translating the address (S306).

The address translation in S304 involves translating, as illustrated in FIG. 15, the destination IP address and the destination MAC address of the packet to be transmitted so that the transmission destination becomes the other adaptor 17B within the self-device.

The address translation in S304 further involves translating, as illustrated in FIG. 15, the source IP address and the source MAC address of the packet to be transmitted so that the transmission source becomes the predetermined virtual machine. To be specific, as illustrated in FIG. 3, for making the communication partner device appear to be the second virtual machine from the adaptor 17B, as in FIG. 15, the source IP address of the packet is set to 10.20.2.2, and the source MAC address is set to MAC22.

The packet transmitted from the adaptor 17A is received by the adaptor 17B via the network cable. The adaptor 17B sends the received packet to the application unit 21 via the driver unit 25B, the IP layer 24, the TCP layer 23 and the stream head 22. Namely, the application unit 21 receives the packet as from the second virtual machine serving as the sender.

Next, the discussion will touch a case in which the communication flowing to the adaptor 17A from adaptor 17B is, as illustrated in FIG. 6, designated by inputting the command for performing the test.

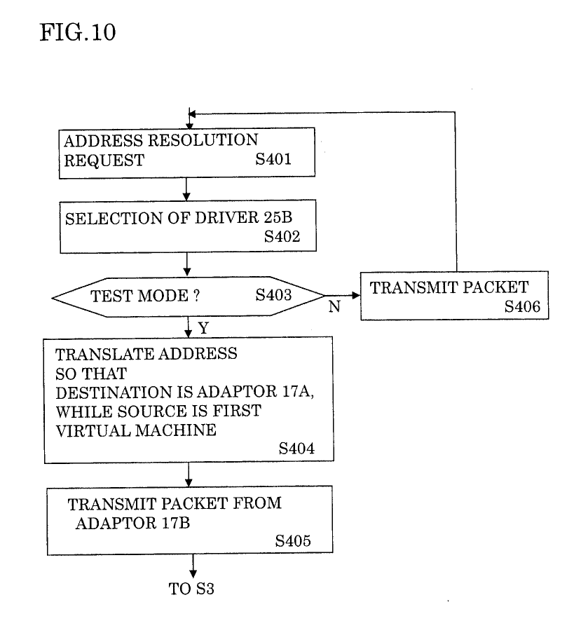

(4) In response to the command for performing the test, the application unit 21 is on the verge of starting the transmission of the packet addressed to the second virtual machine. Herein, the IP address of the second virtual machine is designated differently from the IP addresses of the adaptors within the self-device as described above. Therefore, the IP layer 24 makes, as illustrated in FIG. 10, an address resolution request for requesting the MAC address associated with the destination IP address (S401).

Then, the IP layer 24 selects the driver unit 25B belonging to the same IP subnet as the IP subnet of the destination IP address of the address resolution request packet, and transmits the address resolution request packet to the driver unit 25B (S402).

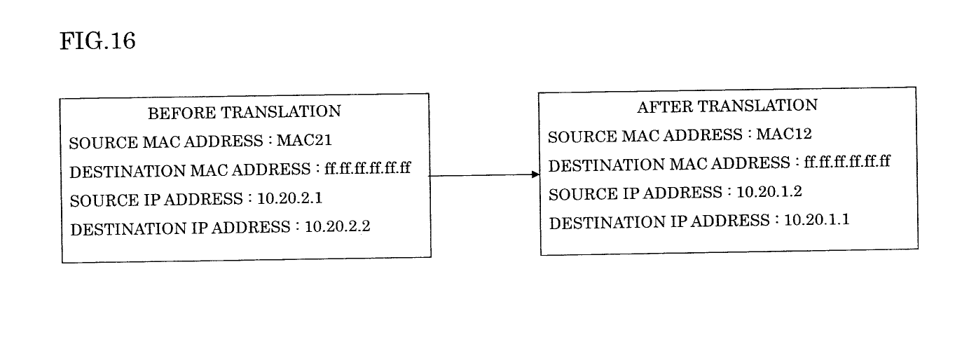

The adaptor 17B or the driver unit 25B receiving the packet determines whether or not the set-up mode is the address translation mode (test mode) (S403). As a result of the determination, if the set-up mode is the address translation mode, as illustrated in FIG. 16, the destination IP address is translated into 10.20.1.1 from 10.20.2.2, the source IP address is translated into 10.20.1.2 from 10.20.2.1, and the source MAC address is translated into MAC12 from MAC21 (S404). Then, the adaptor 17B transmits the packet having the translated address to the outside (S405).

Note that if the set-up mode is determined not to be the address translation mode in S403 but is determined to be the normal mode, the adaptor 17B or the driver unit 25B transmits the packet without translating the address (S406).

Further, the address translation in S404 involves translating, as illustrated in FIG. 16, the destination address of the packet transmitted by the adaptor 17B or the driver unit 25B so that the transmission destination of the packet becomes the other adaptor 17A within the self-device. The example of FIG. 16, however, deals with the address resolution request packet, and hence the destination MAC address of this packet is set to ff.ff.ff.ff.ff.ff for broadcasting.

The address translation in S404 further involves translating, as illustrated in FIG. 16, the source IP address and the source MAC address of the packet to be transmitted so that the transmission source of the packet becomes the predetermined virtual machine. For example, the adaptor 17B, for making the communication partner device appear to be the first virtual machine from the adaptor 17A as illustrated in FIG. 3, sets the source IP address of the packet to be transmitted to 10.20.1.2 and the source MAC address to MAC12 in the example of FIG. 16.

The packet transmitted from the adaptor 17B is received by the adaptor 17A via the network cable. The adaptor 17A sends the received packet to the application unit 21 via the driver unit 25A, the IP layer 24, the TCP layer 23 and the stream head 22. Namely, the application unit 21 receives the packet as from the first virtual machine serving as the sender.

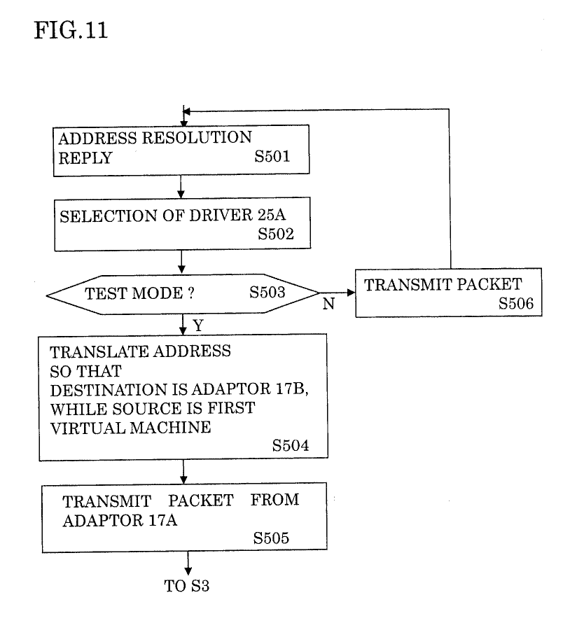

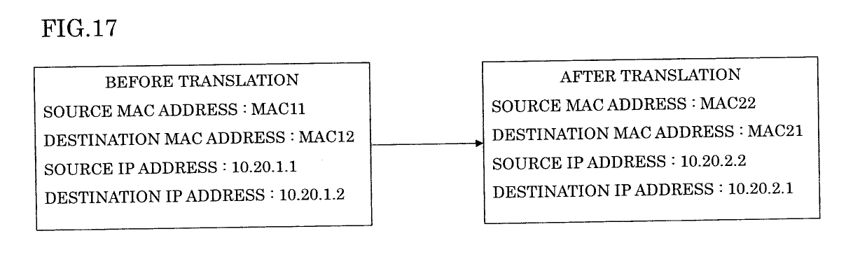

(5) The adaptor 17A or the driver unit 25A translates, when transmitting the address resolution reply (ARP reply), the MAC address and the IP address as illustrated in FIG. 17. The address translation process in the adaptor 17A or the driver unit 25A will hereinafter be described in detail with reference to FIG. 11.

Namely, the application unit 21 sends the address resolution reply back to the first virtual machine (S501).

In this case also, the destination IP address is the first virtual machine but is not within the self-device as illustrated in FIG. 3, and hence the IP layer 24 transmits the packet to the driver unit 25A belonging to the same IP subnet as the IP subnet of the destination IP address (S502).

The adaptor 17A or the driver unit 25A receiving the packet from the IP layer 24 determines whether or not the set-up mode is the address translation mode (test mode) (S503). The adaptor 17A or the driver unit 25A translates, if the set-up mode is the address translation mode, as illustrated in FIG. 17, the destination IP address into 10.20.2.1 from 10.20.1.2, the destination MAC address into MAC21 from MAC12, the source IP address into 10.20.2.2 from 10.20.1.1 and the source MAC address into MAC22 from MAC11 (S504).

Then, the adaptor 17A transmits the packet having the translated address to the outside (S505). Note that if the set-up mode is determined not to be the address translation mode in S503, the adaptor 17A transmits the packet without translating the address (S506).

The address translation in S504 involves translating, as illustrated in FIG. 17, the destination IP address and the destination MAC address of the packet transmitted by the adaptor 17A or the driver unit 25A so that the transmission destination changes to the other adaptor 17B within the self-device from the first virtual machine.

The address translation in S504 further involves translating, as illustrated in FIG. 17, the source IP address and the source MAC address of the packet to be transmitted so that the transmission source changes to the second virtual machine from the adaptor 17A. Namely, as illustrated in FIG. 3, for making the communication partner device appear to be the second virtual machine from the adaptor 17B, in the example of FIG. 17, the source IP address is set to 10.20.2.2, and the source MAC address is set to MAC22.

The packet transmitted from the adaptor 17A is received by the adaptor 17B via the network cable. The adaptor 17B sends the received packet to the application unit 21 via the driver unit 25B, the IP layer 24, the TCP layer 23 and the stream head 22. Namely, the application unit 21 receives the packet as from the second virtual machine serving as the sender.

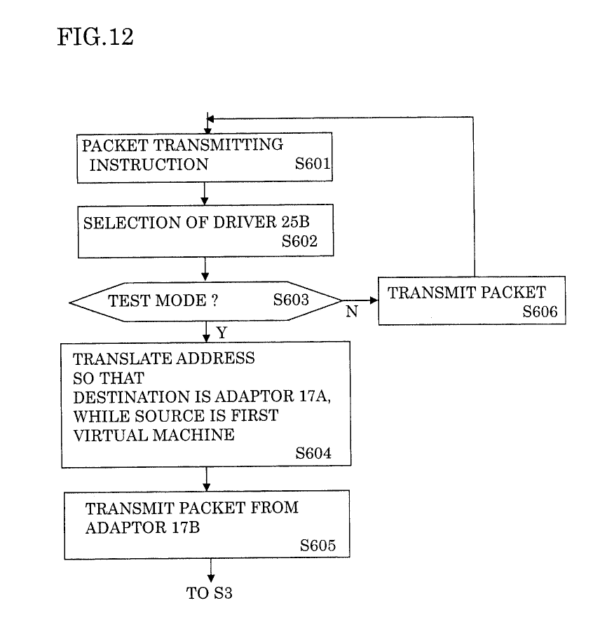

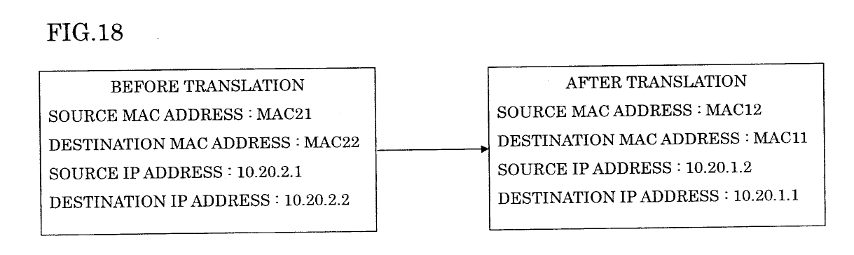

(6) The adaptor 17B or the driver unit 25B translates, when transmitting the TCP/IP packet, the MAC address and the IP address as illustrated in FIG. 18. The address translation process of the adaptor 17B or the driver unit 25B will hereinafter be described in detail with reference to FIG. 12.

The application unit 21, which recognizes the MAC address of the second virtual machine owing to the address resolution, transmits the packet addressed to the second virtual machine (S601).

In this case, the destination IP address is the second virtual machine but is not within the self-device as illustrated in FIG. 3, and hence the IP layer 24 transmits the packet to the driver unit 25B belonging to the same IP subnet as that the IP subnet of the destination IP address (S602).

The adaptor 17B or the driver unit 25B receiving the packet from the IP layer 24 determines whether or not the set-up mode is the address translation mode (test mode) (S603). The adaptor 17B or the driver unit 25B translates, if the set-up mode is the address translation mode, as illustrated in FIG. 18, the destination IP address into 10.20.1.1 from 10.20.2.2, the destination MAC address into MAC11 from MAC22, the source IP address into 10.20.1.2 from 10.20.2.1, and the source MAC address into MAC12 from MAC21 (S604). Then, the adaptor 17B transmits the packet having the translated address to the outside (S605).

Note that if the set-up mode is determined not to be the address translation mode, namely, if determined to be the normal mode in S603, adaptor 17B or the driver unit 25B transmits the packet without translating the address (S606).

The address translation in S604 involves translating, as illustrated in FIG. 18, the destination IP address and the destination MAC address of the packet transmitted by the adaptor 17B or the driver unit 25B so that the transmission destination changes to the other adaptor 17A within the self-device from the second virtual machine.

The address translation in S604 further involves translating, as illustrated in FIG. 18, the source IP address and the source MAC address of the packet to be transmitted so that the transmission source changes to the first virtual machine from the adaptor 17B. To be specific, as illustrated in FIG. 3, for making the communication partner device appear to be the first virtual machine from the adaptor 17A, in the example of FIG. 18, the source IP address of the packet is set to 10.20.1.2, and the source MAC address is set to MAC12.

The packet transmitted from the adaptor 17B is received by the adaptor 17A via the network cable. The adaptor 17A sends the received packet to the application unit 21 via the driver unit 25A, the IP layer 24, the TCP layer 23 and the stream head 22. Namely, the application unit 21 receives the packet as from the first virtual machine serving as the sender.

As described above, the computer 1 performs the test in S2 of FIG. 4 according to the procedures of FIGS. 7 through 13 by repeating the communications between the adaptors 17A, 17B in a way that makes the communication partner device with the adaptor 17A appear to be the first virtual machine and makes the communication partner device with the adaptor 17B appear to be the second virtual machine (S3).

Then, the application unit 21 obtains the quantity of the transmitted/received data and the transmission/reception speed and sets the data quantity and the speed as the test results (S4); and the application unit 21 executes the output process such as writing the test results to the recording medium, displaying the results on the display device, transmitting the results to other computers and printing the results (S5).

—User Interface—

The transition to the address translation mode, namely, the test mode and cancellation of this mode are designated based on commands by the user.

Herein, the computer 1 is assumed to be in the status of FIG. 1, namely, the status is that, on one single testing device, the adaptors 17A, 17B are directly connected via the cable, the driver unit 25A is associated with the IP address IP11=10.20.1.1, and the driver unit 25B is associated with the IP address IP21=10.20.2.1.

For example, [addrtrans-s] is used as a command for transitioning to the address translation mode. Further, when inputting this command, for designating the communication direction and the address of the virtual machine, the user designates as below from the input unit 15.

>addrtrans -s driver#1 10.20.1.2 driver#2 10.20.2.2

Herein, [driver#1] is defined as a driver name of the driver unit 25A, [driver#2] is defined as a driver name of the driver unit 25B, [10.20.1.2] is the IP address of the first virtual machine, [10.20.2.2] is the IP address of the second virtual machine.

On the other hand, for example, [addrtrans -d] is used as a command for canceling the address translation mode, namely, for setting the normal mode. When inputting this command, in order to designate the driver which cancels the address translation mode, the user designates as below from the input unit 15.

>addrtrans -d driver#1 driver#2

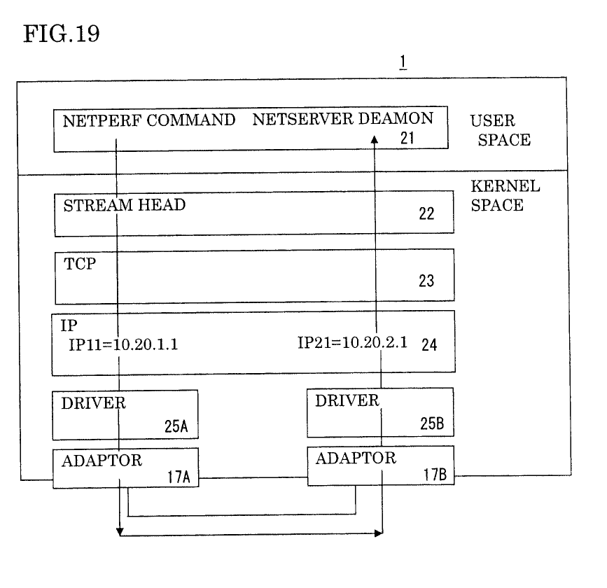

FIG. 19 is a diagram illustrating a transmission route when performing the communication flowing to the adaptor 17B from the adaptor 17A when in the test mode.

After transitioning to the address translation mode, the packet is transmitted in a way that designates the IP address (IP12=10.20.1.2) of the first virtual machine as the designation IP address, in which case through the translation processes (1)-(3) described above, as illustrated in FIG. 19, the packet can be transmitted via netperf command 21→stream head 22→TCP23→IP24→driver 25A→adaptor 17A→adaptor 17B→driver 25B→IP24→TCP23→stream head 22→netserver Daemon 21.

For example, [netperf] is used as a command for transmitting the packet for conducting the test. The command is executed as below after transitioning to the address translation mode.

>netperf -H 10.20.1.2

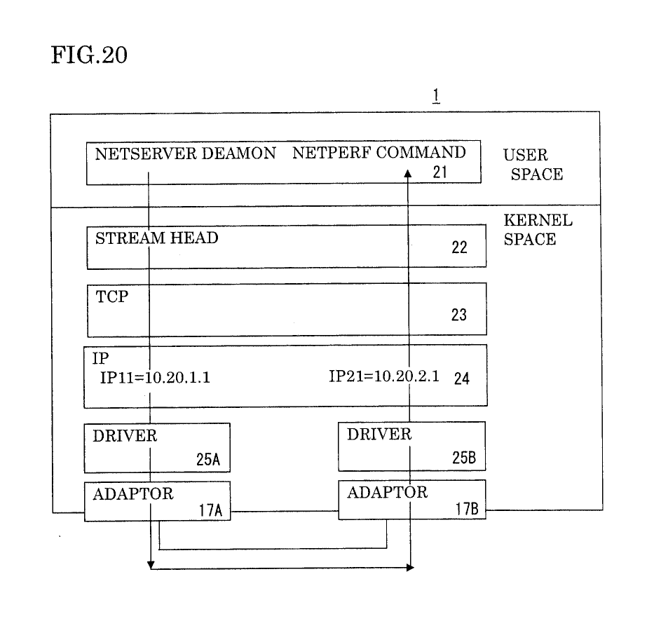

Further, FIG. 20 is a diagram illustrating a transmission route when performing the communication flowing to the adaptor 17B from the adaptor 17A when in the test mode.

After transitioning to the address translation mode, the packet is transmitted in a way that designates the IP address (=IP12=10.20.2.2) of the second virtual machine, in which case through the translation processes (4)-(6) described above, as illustrated in FIG. 20, the packet can be transmitted via netperf command 21 stream head 22→TCP23→IP24→driver 25B→adaptor 17B→adaptor 17A→driver 25A→IP24→TCP23→stream head 22→netserver Daemon 21.

For instance, after transitioning to the address translation mode, the command is executed as follows.

>netperf -H 10.20.2.2

—Implementation of Command in the Case of Translating Address by Adaptor—

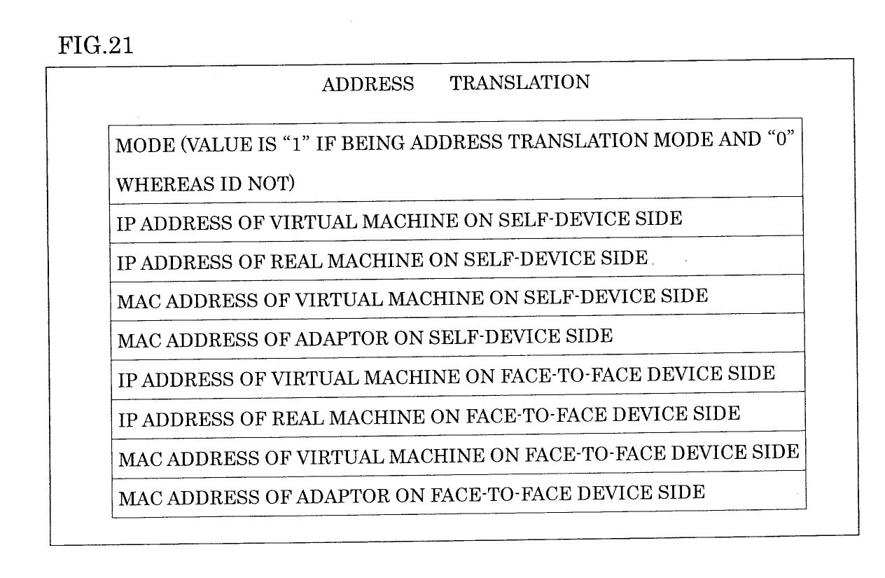

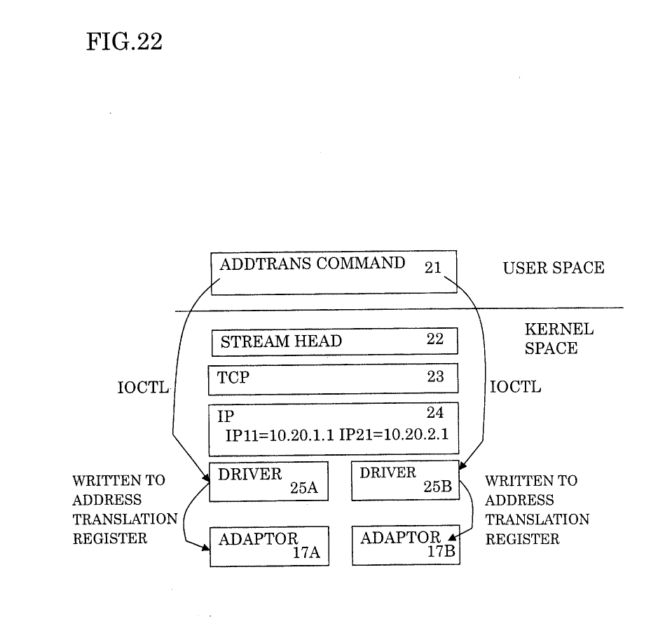

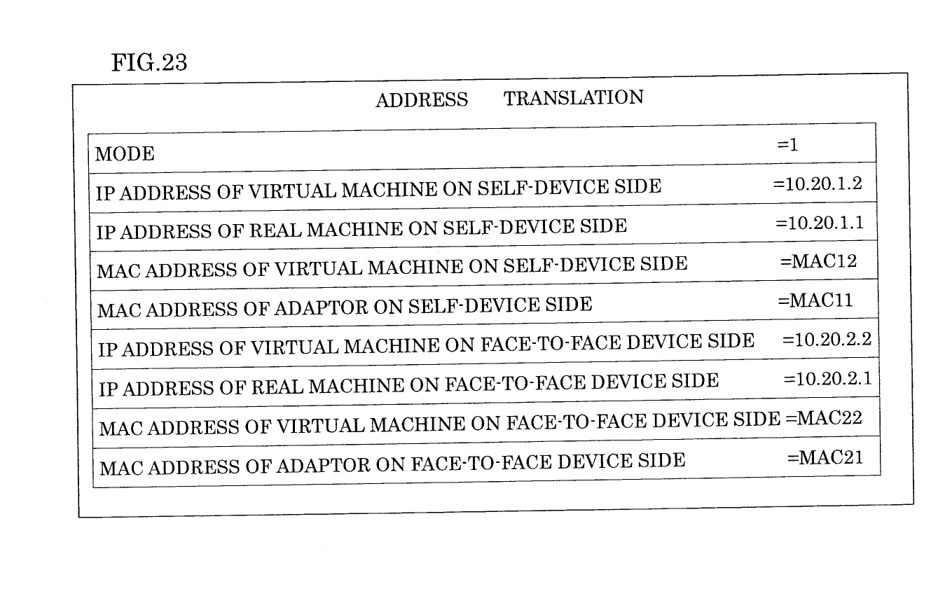

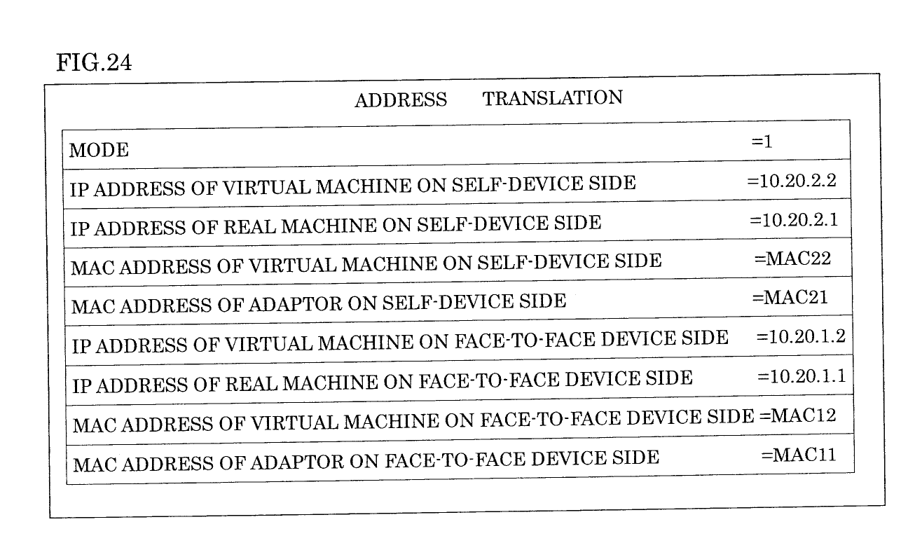

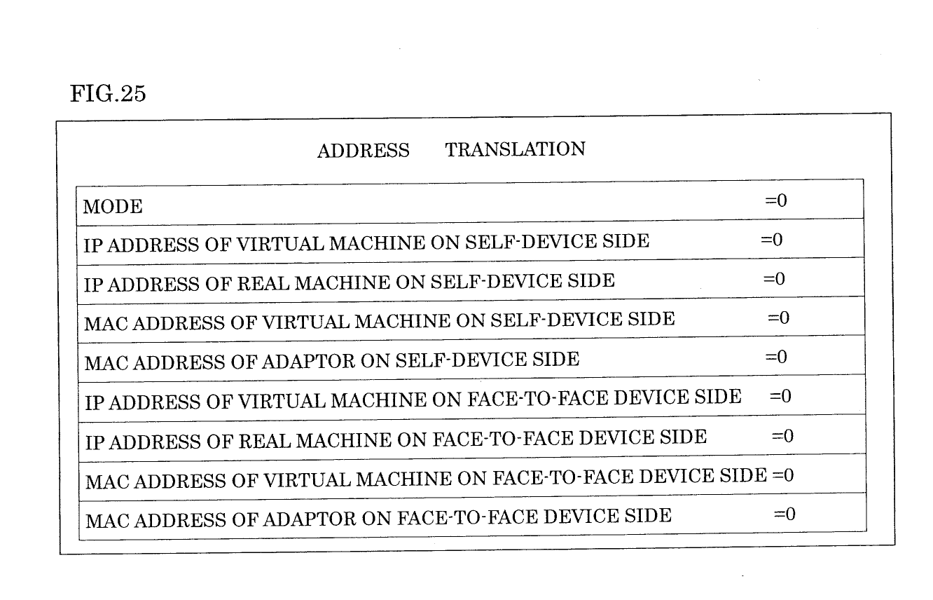

FIG. 21 is an explanatory diagram of an address translation register; FIG. 22 is an explanatory diagram of an updating process of the address translation register; FIG. 23 is a diagram illustrating one example of values written to the address translation register of the adaptor 17A; FIG. 24 is a diagram illustrating one example of values written to the address translation register of the adaptor 17B; and FIG. 25 is a diagram illustrating an example of setting the normal mode by clearing the value of the address translation register.

An area illustrated in FIG. 21, namely, the address translation register is ensured in a predetermined location in the memory space on each of the adaptors 17A, 17B.

The address translation register in FIG. 21 is stored with items such as the mode that is now set up, the IP address of the virtual machine on the side of the self-device, the IP address of the real machine on the side of the self-device, the MAC address of the virtual machine on the side of the self-device, the MAC address of the adaptor on the side of the self-device, the IP address of the virtual machine on the side of the face-to-face device, the IP address of the real machine on the side of the face-to-face device, the MAC address of the virtual machine on the side of the face-to-face device and the MAC address of the adaptor on the side of the face-to-face device.

Note that the now-set-up mode is set to “1” if being the address translation mode and “0” if being the normal mode. Further, in the case of the address translation register of the adaptor 17A, the virtual machine on the side of the self-device is the first virtual machine, the virtual machine on the side of the face-to-face device is the second virtual machine, the address of the real machine on the side of the self-device is the address of the adaptor 17A, and the address of the real machine on the side of the face-to-face device is the address of the adaptor 17B.

Then, the assumption is that the CPU 12 carries out the following operations in the case of executing the command “addrtrans -s”.

To begin with, a search for the MAC addresses and the IP addresses of the adaptors 17A, 17B is made through the existing interface provided in the OS, and the IP address of the real machine on the side of the self-device of the address translation register, the MAC address of the adaptor on the side of the self-device, the IP address of the real machine on the side of the face-to-face device and the MAC address of the adaptor on the side of the face-to-face device are stored. Note that the MAC addresses and the IP addresses are associated with the driver names related to the adaptors 17A, 17B by the OS and stored in the memory.

Next, the MAC addresses are allocated to the first virtual machine and the second virtual machine and are stored as the MAC address of the virtual machine on the side of the self-device of the address translation register and the MAC address of the virtual machine on the side of the face-to-face device. Values thereof are MAC21 and MC22. Herein, MAC21 and MAC22 are allocated so as to make unique the MAC address “MAC21” of the first virtual machine, the MAC address “MAC22” of the second virtual machine, the MAC address “MAC11” of the adaptor 17A, and the MAC address “MAC12” of the adaptor 17B.

The IP addresses of the first virtual machine and the second virtual machine are each given by an argument of the command “addrtrans -s”, and hence this argument is stored as the IP address of the virtual machine on the side of the self-device of the address translation register and as the IP address of the virtual machine on the side of the face-to-face device.

Next, as illustrated in FIG. 22, based on a command, e.g., “ioctl” (I/O control) of controlling the driver, the application unit 21 hands over values to be written to the address translation registers of the adaptor 17A and the adaptor 17B, respectively to the driver units 25A, 25B.

The driver units 25A, 25B, upon receiving “ioctl”, writes the values of the respective items received in response to “ioctl” to the address translation registers of the adaptors 17A, 17B corresponding to the individual driver units.

For instance, in the case of executing “addrtrans -s driver#1 10.20.1.2 driver#2 10.20.2.2”, the driver unit 25A writes, as illustrated in FIG. 23, the respective items of information to the address translation register of the adaptor 17A.

To be specific, the mode is “1”, the IP address of the virtual machine on the side of the self-device is “10.20.1.2”, the IP address of the real machine on the side of the self-device is “10.20.1.1”, the MAC address of the virtual machine on the side of the self-device is “MAC12”, the MAC address of the adaptor on the side of the self-device is “MAC11”, the IP address of the virtual machine on the side of the face-to-face device is “10.20.2.2”, the IP address of the real machine on the side of the face-to-face device is “10.20.2.1”, the MAC address of the virtual machine on the side of the face-to-face device is “MAC22”, and the MAC address of the adaptor on the side of the face-to-face device is “MAC21”.

Similarly, the driver unit 25B writes, as illustrated in FIG. 24, the respective items of information to the address translation register of the adaptor 17B.

Then, in the case of executing “addrtrans -d driver#1 driver#2” and canceling the address translation mode, as illustrated in FIG. 25, the driver unit 25A instructs the adaptor 17A to clear all of the values of the address translation register into “0”, and the driver unit 25B instructs the adaptor 17B to clear all of the values of the address translation register into “0”.

—Implementation of Command in the Case of Translating Address by Driver—

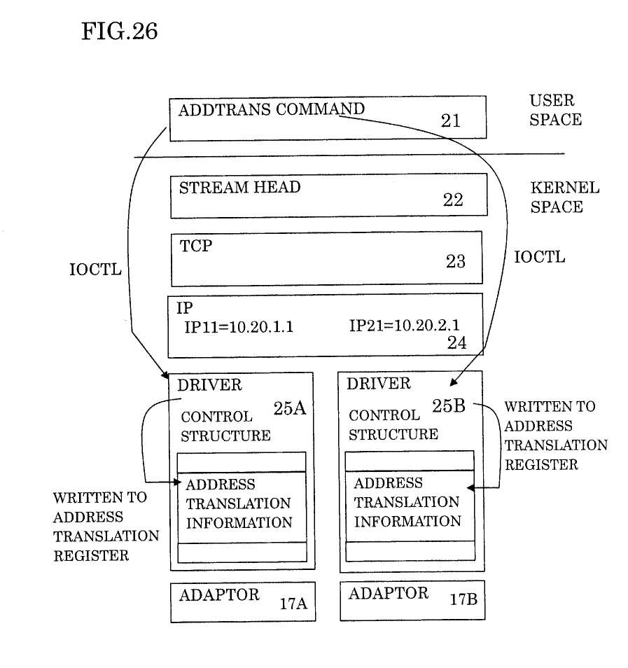

FIG. 26 is an explanatory diagram of an updating process of address translation information.

Each of the driver units 25A, 25B retains, on the memory 13 of the computer 1, a data structure called a “control structure” in order to save a status of the adaptor and information indicated from a high-order element.

The information equal to the information in the address translation register in FIG. 21 is taken into the control structure. This information is called the “address translation information”.

The process to the point of the process of transferring the values to be written to the address translation information to each of the driver units 25A, 25B according to “ioctl” is the same as the process of transferring the values to be written to the address translation register in FIG. 22 description detail of the process of writing the address translation information will hereinafter be made.

The driver units 25A, 25B, upon receiving “ioctl”, as illustrated in FIG. 26, update the values of the control structure. For example, in the case of executing “addrtrans -s driver#1 10.20.1.2 driver#2 10.20.2.2”, the driver unit 25A writes the values illustrated in FIG. 23 as the address translation information of the control structure. Further, the driver unit 25B writes the values illustrated in FIG. 24 as the address translation information of the control structure.

On the other hand, in the case of executing “addrtrans -d driver#1 driver#2” and canceling the address translation mode, as illustrated in FIG. 25, each of the driver units 25A, 25B clears the address translation information of the control structure.

—Implementation Example of Adaptor in the Case of Translating Address by Adaptor—

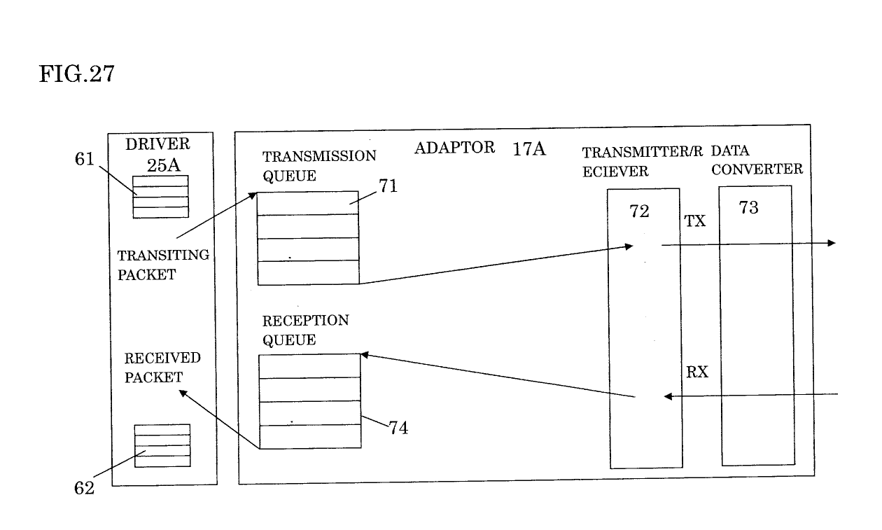

FIG. 27 is a function block diagram of the adaptor, illustrating a status when in the normal mode, namely, in the case of performing the normal communications. Note that the adaptors 17A, 17B have the same configuration and execute the same process, by contrast, when transmitting and when receiving, and hence for the convenience's sake the discussion touches the adaptor 17A, while omitting the description of the adaptor 17B. Further, this is the same with the driver units 25A, 25B, so that the description of the driver unit 25B will be omitted.

As illustrated in FIG. 27, the adaptor 17A includes a transmission queue 71, a transmitter/receiver 72, a data converter 73 and a reception queue 74.

When the driver unit 25A requests the adaptor 17A to transmit the packet, the transmission packet is, to begin with, registered in the transmission queue 71 and sent based on FIFO (First-In, First-Out) to the transmitter/receiver 72.

The transmitter/receiver 72 attaches error detection bits for detecting an error on the transmission path to the packet sent from the transmission queue 71, thus designating the transmission of the packet. Up to this stage, the packet takes a bit-string format of “0” and “1”.

Then, the packet receiving the designation of the transmission from the transmitter/receiver 72 reaches the data converter 73, then converted into an electric signal format or an optical signal format, and transmitted to the transmission path such as a LAN (Local Area Network) cable.

The reception packet taking the electric signal format or the optical signal format enters the data converter 73 from the transmission path.

The data converter 73 converts the packet into the bit -string of “0” and “1”.

The transmitter/receiver 72 compares the error detection bits of the received packet with contents of the data other than the error detection bits, thereby checking whether the error occurs on the transmission path or not. If the reception packet undergoes the occurrence of the error, the received data is discarded, and the driver unit 25A is notified of the occurrence of the error. Whereas if any error does not occur, the transmitter/receiver 72 removes the error detection bits, then registers the reception packet in the reception queue 74, and notifies the driver unit 25A of the occurrence of the reception via an interrupt etc.

The driver unit 25A takes the packets out of the reception queue 74 in a first-arrival sequence.

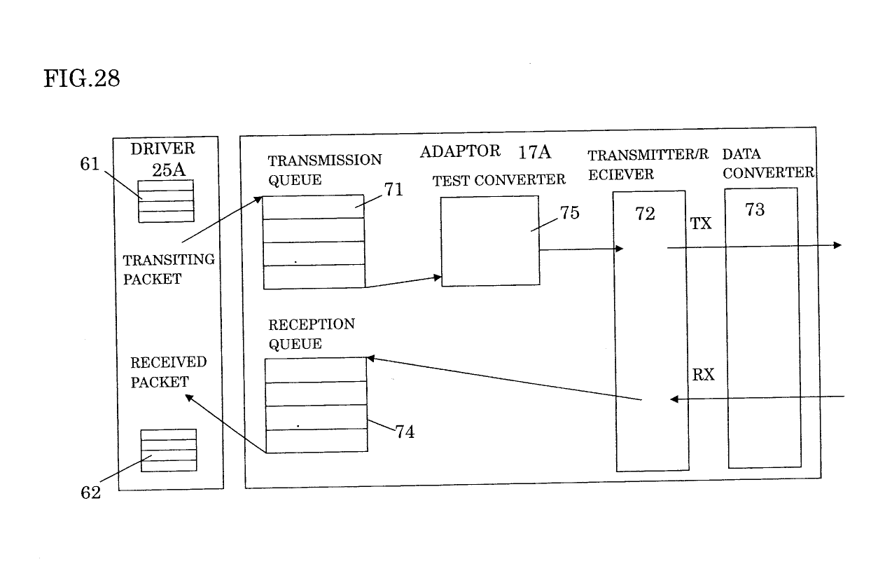

On the other hand, FIG. 28 is a function block diagram of the adaptor 17A, illustrating a status in the case of translating the address.

When in the test mode, namely, in the case of performing the communications in a way that translates the address, the first embodiment involves using, as illustrated in FIG. 28, a test converter 75 for translating the packet address between the transmission queue 71 and the transmitter/receiver 72.

The packet transmitted to the adaptor 17A from the memory 13 of the main body by the driver unit 25A is written to the memory of the adaptor 17A, namely, written to the transmission queue 71. The packet at this stage is, though merely different depending on being written to the memory 13 of the main body or to the memory of the adaptor 17A, expressed in the bit format of “0” and “1”, and the contents of the packet are the same as when existing on the memory of the main body. Moreover, the packet is not attached with the error detection bits till before entering the transmitter/receiver 72.

The test converter 75 reads the packet from the transmission queue 71, then translates the packet address as in the processes (1)-(3), and transmits the packet to the transmitter/receiver 72. The process of transmitting the packet via the transmitter/receiver 72 and the data converter 73 is the same as the process in FIG. 27. Further, even in the test mode, the packet receiving process is the same as in the normal mode.

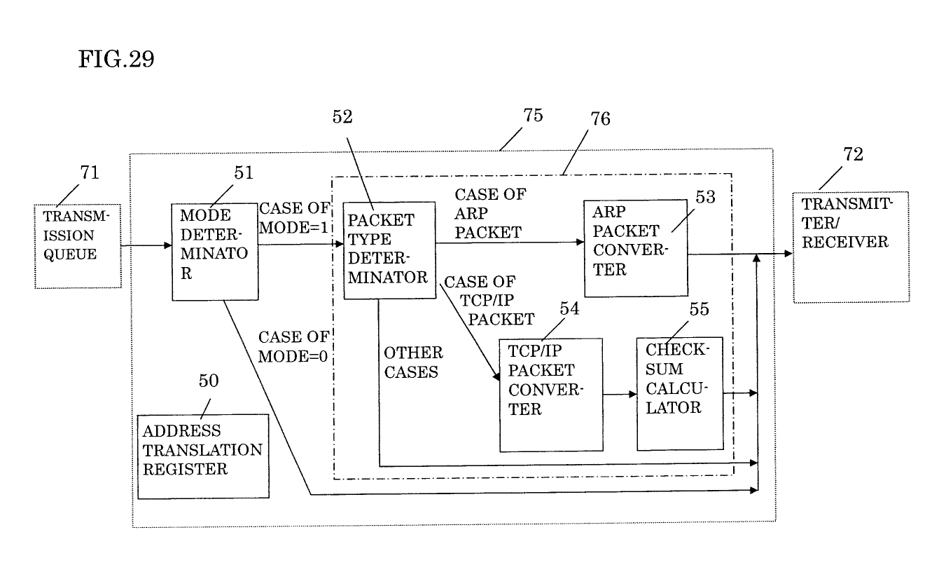

FIG. 29 is a diagram of a configuration of the test converter 75. As illustrated in FIG. 29, the test converter 75 includes an address translation register 50, a mode determinator 51 and an address translation unit 76. Moreover, the address translation unit 76 has a packet type determinator 52, an ARP packet converter 53, a TCP/IP packet converter 54 and a checksum calculator 55.

The address translation register 50 stores the contents illustrated in FIG. 21 and is the register to which the mode determinator 51, the ARP packet converter 53 and the TCP/IP packet converter 54 refer.

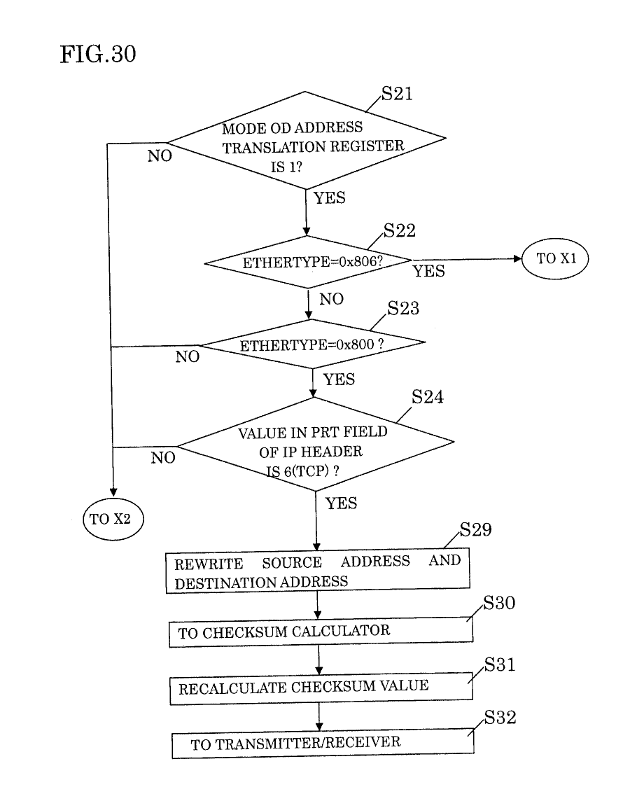

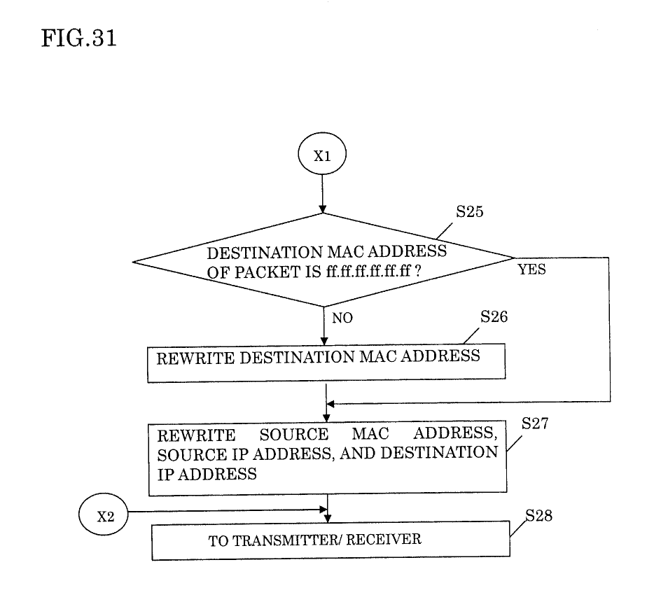

The respective components 51-55 of the test converter 75 execute a process illustrated in FIGS. 30 and 31. FIGS. 30 and 31 are explanatory diagrams of the address translation process.

To start with, the mode determinator 51 refers to the address translation register 50 and thus determines whether the mode is “1”, namely, the mode is the test mode or not (S21). The mode determinator 51, if the mode is “1” (S21; Yes), reads the first packet from the transmission queue 71 and transmits this packet to the packet type determinator 52. Whereas if the mode is “0” (S21; No), the mode determinator 51 transmits the packet read from the transmission queue 71 to the transmitter/receiver 72 without converting this packet, namely, without via the address translation unit 76. In this case, the processing transitions to X2.

The packet type determinator 52 receiving the packet from the mode determinator 51 determines whether an Ethertype of the packet is “0x806” or not (S22). If the Ethertype is “0x806”, this indicates that the packet is categorized into an ARP request or an ARP reply. Accordingly, the packet type determinator 52, if the Ethertype is “0x806” (S22; Yes), transmits the packet to the ARP packet converter 53. In this case, the processing transitions to X1.

Further, the packet type determinator 52, whereas if the Ethertype is not “0x806” (S22; No), determines whether the Ethertype is “0x800” or not (S23). If the

Ethertype is “0x800” (S23; Yes), this indicates that the packet is an IP packet. Therefore, the packet type determinator 52, if the Ethertype is not “0x800” (S23; No), transmits the packet directly to the transmitter/receiver without converting the packet. In this case, the processing transitions to X2.

Then, the packet type determinator 52, if the Ethertype is “0x800” (S23; Yes), determines whether a value of a “PRT” field of an IP header is “6”, namely, TCP or not (S24). Herein, if the value of the “PRT” field is “6” (S24; Yes), the packet type determinator 52 transmits the packet to the TCP/IP packet converter 54. On the other hand, if the value of the “PRT” field is not “6” (S24; No), the packet type determinator 52 transmits the packet directly to the transmitter/receiver 72 without converting the packet. In this case, the processing transitions to X2.

The ARP packet converter 53 receiving the ARP packet from the packet type determinator 52 determines whether the destination MAC address of the packet is a broadcast address, namely, “ff.ff.ff.ff.ff.ff” or not (S25).

If the MAC address of the ARP packet is not the broadcast address (S25; No), the ARP packet converter 53 acquires the MAC address of the network adaptor on the side of the face-to-face device by referring to the address translation register 50, and rewrites the destination MAC address of the packet with the acquired MAC address (S26).

After the rewriting the destination MAC address in S26 or if the destination MAC address is determined to be the broadcast address in S25 (S25; Yes), the ARP packet converter 53 rewrites the following addresses in a way that refers to the address translation register 50 (S27).

1. The source MAC address is rewritten with the MAC address of the virtual machine on the side of the face-to-face device.

2. The source IP address is rewritten with the IP address of the virtual machine on the side of the face-to-face device.

3. The destination IP address is rewritten with the IP address of the adaptor on the side of the face-to-face device.

Then, the ARP packet converter 53 sends the post-converting packet to the transmitter/receiver 72 (S28).

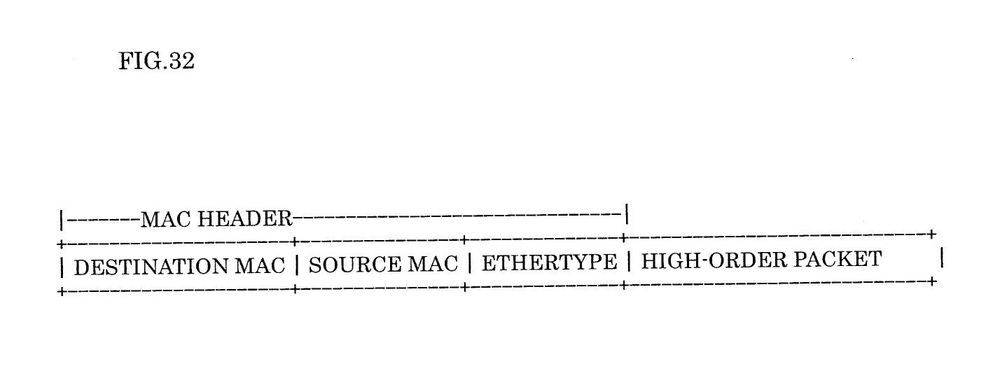

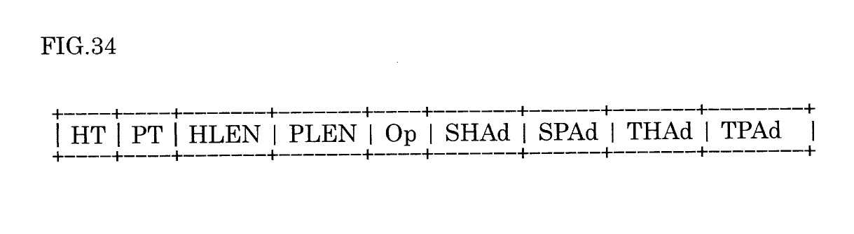

Note that in the ARP packet converted by the ARP packet converter 53, the source MAC address corresponds to “SOURCE MAC” in the MAC header illustrated in FIG. 32 and a format “SHAd” illustrated in FIG. 34. The rewriting process described above is executed for both of “SOURCE MAC” and “SHAd”.

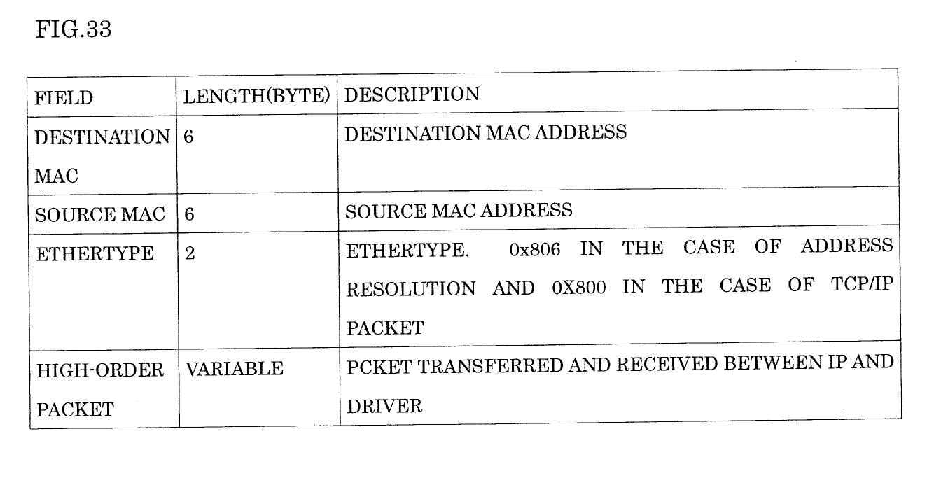

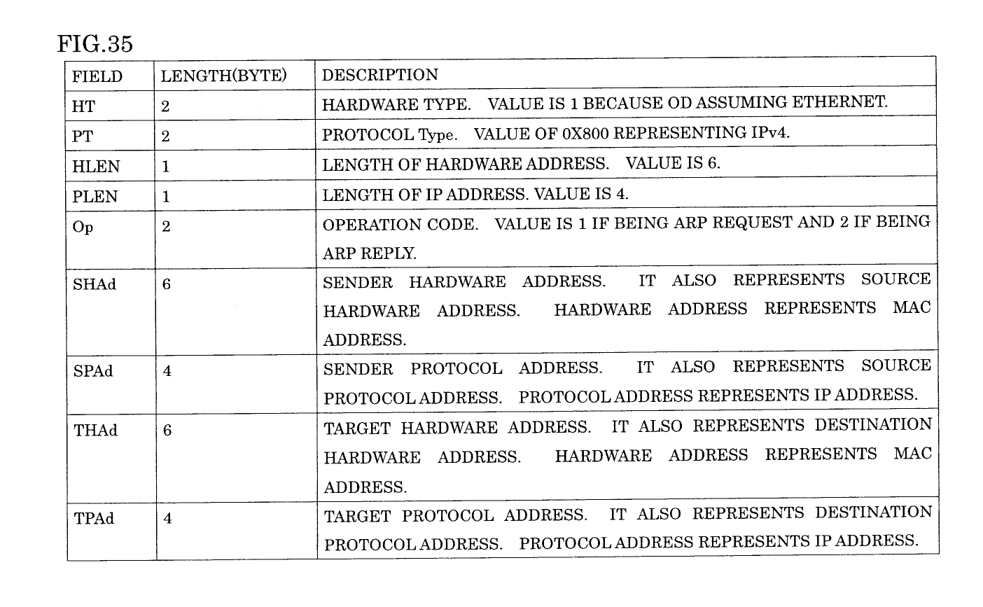

FIG. 32 is a diagram illustrating a packet format including the MAC header; FIG. 33 is an explanatory diagram of respective fields in FIG. 32; FIG. 34 is a diagram illustrating a format of the ARP packet; and FIG. 35 is an explanatory diagram of the respective fields in FIG. 34.

Further, the destination MAC address corresponds to “DESTINATION MAC” in the MAC header illustrated in FIG. 32 and a format “THAd” illustrated in FIG. 34, and the rewriting process described above is executed for both of “DESTINATION MAC” and “THAd”.

Moreover, the source IP address corresponds to a format “SPAd” illustrated in FIG. 34, and the destination IP address corresponds to a format “TPAd” illustrated in FIG. 34.

Further, the TCP/IP packet converter 54, which has received the TCP/IP packet from the packet type determinator 52, rewrites the following addresses by referring to the address translation register 50 (S29).

1. The source MAC address is rewritten with the MAC address of the virtual machine on the side of the face-to-face device.

2. The destination MAC address is rewritten with the MAC address of the adaptor on the side of the face-to-face device.

3. The source IP address is rewritten with the MAC address of the adaptor on the side of the face-to-face device.

4. The destination IP address is rewritten with the IP address of the adaptor on the side of the face-to-face device.

Then, the TCP/IP packet converter 54 transmits the post-converting packet to the checksum calculator 55 (S30).

Note that with respect to the TCP/IP packet converted by the TCP/IP packet converter 54, the source MAC address corresponds to “SOURCE MAC” in the MAC header illustrated in FIG. 32.

Similarly, the destination MAC address corresponds to “DESTINATION MAC” in the MAC header illustrated in FIG. 32.

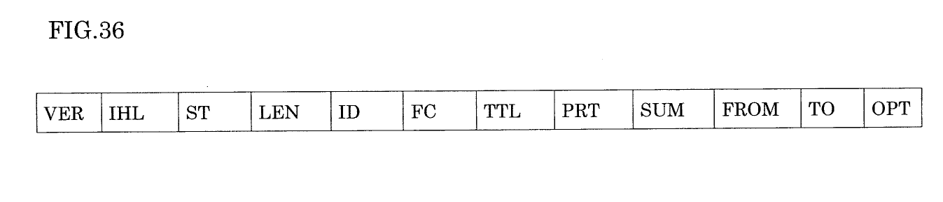

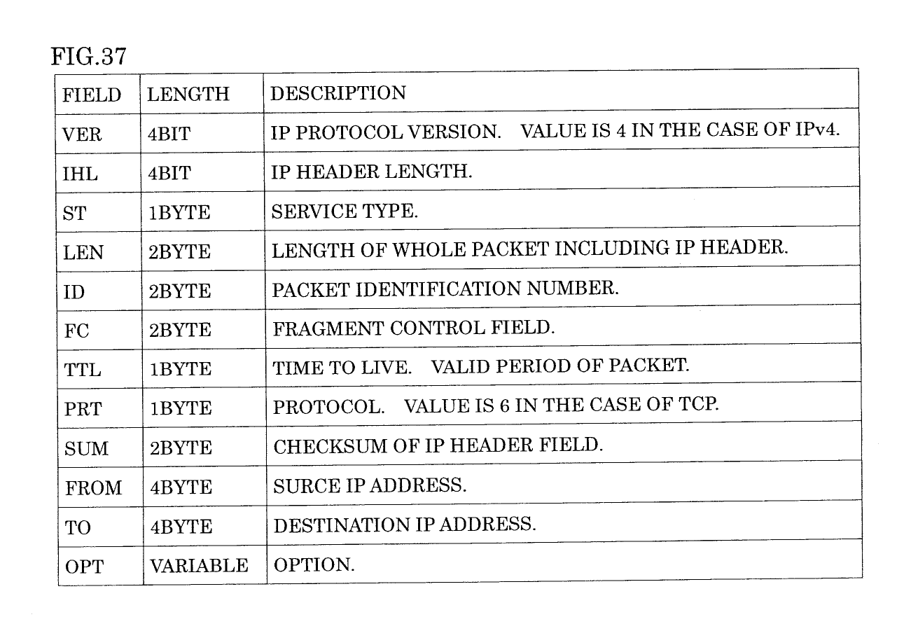

Moreover, the source IP address corresponds to “FROM” in the IP header illustrated in FIG. 36, and the destination IP address corresponds to “TO” in the IP header depicted in FIG. 36. FIG. 36 is a diagram illustrating a format in the IP header, and FIG. 37 is an explanatory diagram of the respective fields of the IP header in FIG. 36.

It is noted that each of the adaptors does not use the its own address registered in the address translation register for the address translation process but may apply its own address to a validity check of the packet before the address translation (overwriting) in the first embodiment.

For example, the adaptor checks whether or not, as illustrated in FIG. 3, the pre-translation source address is coincident with the adaptor's own address and the pre-translation destination address is coincident with the address of the face-to-face virtual machine.

Herein, if not valid, namely, if the addresses are not coincident with each other, such a measure is taken that the adaptor notifies the driver of an error, while the driver receiving an error notification and outputs an error message. Further, as for an invalid packet, such a measure is taken that the invalid packet is discarded without being transmitted or is transmitted without being converted.

This validity check prevents, if requested to transmit a beyond-assumption packet, an incorrect value of performance from being measured. Note that the beyond-assumption packet might occur in a case where the machine is set to an IP router and a packet coming from another network is intermingled due to an IP forwarding function.

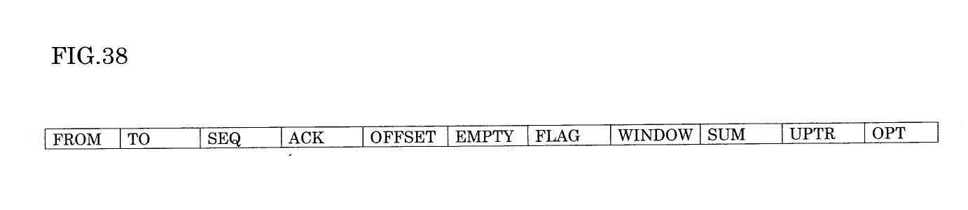

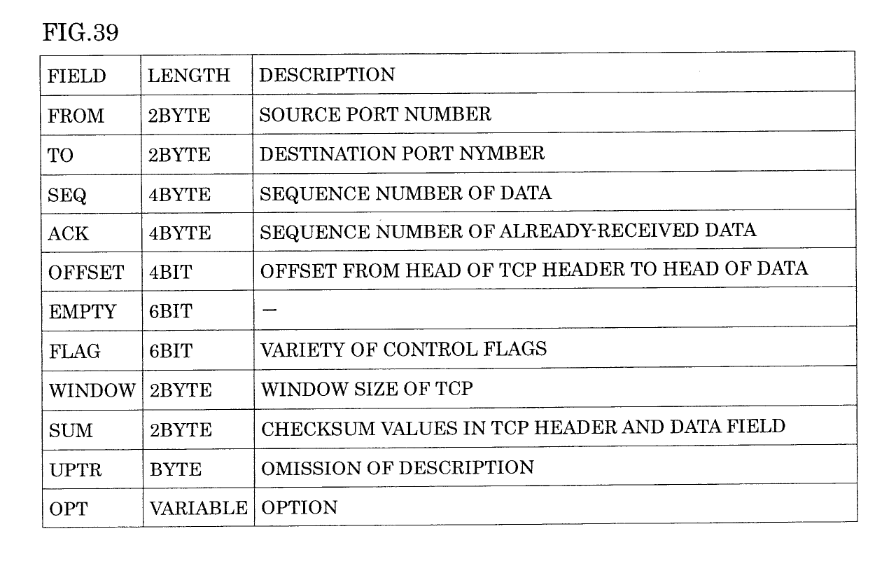

When the TCP/IP packet converter 54 overwrites the address, a checksum value (SUM in FIGS. 36, 37) in the IP header and a checksum value (SUM) in the TCP header illustrated in FIGS. 38, 39 do not take proper values. Such being the case, the packet after undergoing the address translation is inputted to the checksum calculator 55, and the checksum value in the IP header and the checksum value in the TCP header are recalculated and thus overwritten with the recalculated values. Note that the adaptor can perform the calculation itself of the checksum value in the IP header and the checksum value in the TCP header by use of an existing technique called “Checksum Offload” or “Hardware Checksum”.

The checksum calculator 55, upon receiving the post-converting packet from the TCP/IP packet converter 54, reads values from within the respective fields such as VER, IHL, ST, LEN, ID, FC, TTL, PRT, FROM, TO and OPT of the IP header of the packet, then recalculates the checksum value, and overwrites the value of the checksum (SUM) of the packet with the calculated value. Similarly, the checksum calculator 55 reads values from within the respective fields of the TCP header, then recalculates the checksum value, and overwrites the value of the checksum (SUM) of the packet with the calculated value (S31).

Then, the checksum calculator 55 transmits the packet with the revised checksum to the transmitter/receiver 72 (S32).

—Example of Implementation of Driver in the Case of Translating Address by Driver—

Each of the driver units 25A, 25B, when transmitting, namely, each time the packet is transmitted, receives the elements building up the MAC header such as the source MAC address, the destination MAC address and the Ethertype in addition to the transmission packet from the high-order device, namely, the system component on an upstream side of a flow of the transmission process. Hereafter, a set of the transmission packet+the source MAC address+the destination MAC address+Ethertype will be referred to as a transmission stream message.

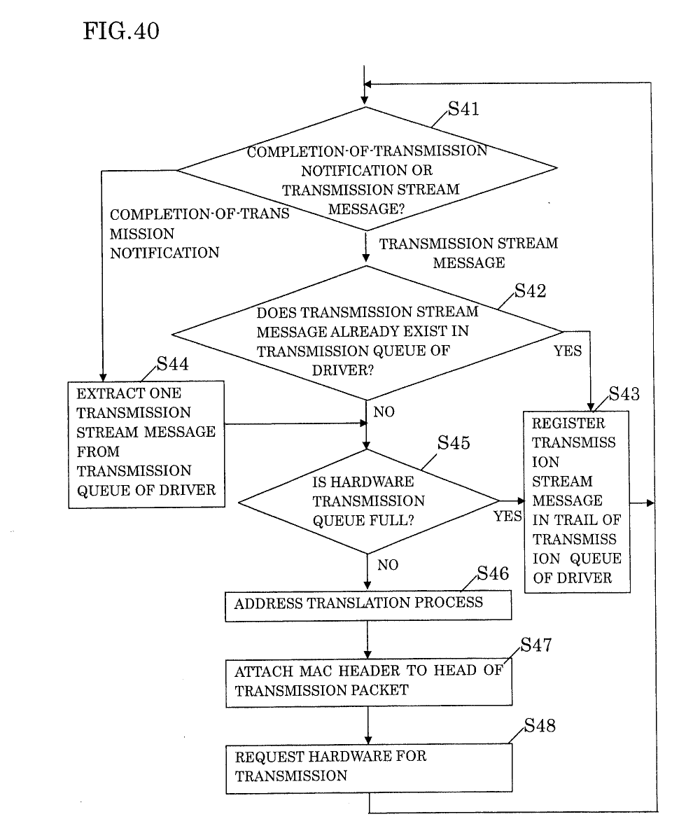

FIG. 40 is an explanatory diagram of the process when transmitting the packet by the driver unit 25A or 25B. For the convenience's sake, the driver 25A will hereinafter be described, however, the description is the same with the driver 25B.

The driver 25A waits for receiving transmission-related information such as the transmission stream message and a piece of completion-of-transmission notification (S41). In the case of receiving the transmission stream message, it is determined whether or not the transmission stream message has already existed in the transmission queue 61 of the driver 25A or 25B (S42).

Herein, if the transmission stream message has already existed in the transmission queue 61 (S42; Yes), the driver 25A or 25B registers the received transmission stream message in the tail of the transmission queue 61 (S43), and waits for receiving the next information (S41).

On the other hand, in S41, in such a status that the transmission stream message is registered in the transmission queue 61, when receiving the completion-of-transmission notification, the driver 25A or 25B extracts, from the transmission queue 61, one transmission stream message headed in this queue 61 (S44).

After S44 or if the transmission stream message is determined not to exist in the transmission queue 61 of the driver 25A or 25B (S42; No), the driver 25A or 25B determines whether or not the transmission queue 71 of the adaptor 17A or 17B is full of the messages (S45).

Herein, if the transmission queue 71 of the adaptor 17A or 17B is full of the messages (S45; Yes), the driver 25A or 25B registers the received transmission stream message in the tail of the transmission queue 61 (S43), and waits for the next information (S41). Further, whereas if the transmission queue 71 of the adaptor 17A or 17B is not full of the messages (S45; No), the adaptor 17A or 17B transitions to step 46 of translating the address.

In S46, the driver 25A or 25B executes the address translation process illustrated in FIGS. 30 and 31. To be specific, in place of the mode determinator 51 and the address translation unit 76, the CPU 12 carries out the same process as in FIGS. 22 and 23.

Then, the driver 25A or 25B attaches the MAC header to the packet after its address has been translated (S47), then sends the packet to the adaptor 17A or 17B and thereby requests the adaptor 17A or 17B to transmit the packet (S48), and loops back to S41.

—Operation in Test Mode—

The following is a description of an operation of the application unit 21 executing the process based on “netperf”, in which “netperf” is used as a performance measuring application.

“Netperf” consists of a transmission application executed based on a “netperf” command and “netserver” Daemon defined as a reception application. Owing to the transmission application, the CPU 12 functions as the transmission application unit described above and transmits the packet for measuring the performance. Moreover, owing to the reception application, the CPU 12 functions as the reception application unit described above and receives the packet transmitted by the transmission application.

To start with, when the “netserver” command is inputted, the CPU 12 boots the “netserver” Daemon. The Daemon is thereby generated in the user space, thus enabling the process to be executed on the receiving side in response to the “netperf” command.

Further, as discussed above, upon inputting the “addrtrans -s” the CPU 12 executes this command and transitions to the test mode.

Then, upon inputting the next “netperf” command, the application unit 21 transmits the data to the address specified by option, namely, to the first virtual machine in the first embodiment.

>netperf -H 10.20.1.2 . . .

When the application unit 21 gives an instruction of transmitting the packet in response to the “netperf” command, the IP layer 24, to being with, since the MAC address associated with the destination IP address “10.20.1.2” is unknown, generates an ARP request in pre-translation setting illustrated in FIG. 13.

The ARP request in the pre-translation status is given to an address that does not exist within the self-device and is therefore transferred to the driver unit 25A of the adaptor 17A belonging to the same IP subnet as the subnet of the destination IP address.

The driver unit 25A or the adaptor 17A translates the address of the ARP request so as to match with the post-translation setting depicted in FIG. 5 and broadcasts this ARP request.

The ARP request is received by the other adaptor 17B via the cable and transmitted to the driver unit 25B and the IP layer 24 in sequence.

The ARP request is, if the source is the second virtual machine depicted in FIG. 3 and the destination is the adaptor 17B, translated in the same way as the ARP request broadcasted from the second virtual machine is translated. Accordingly, even the ARP request transmitted from the adaptor 17A is received in the sequence such as the adaptor 17B, the driver unit 25B the IP layer 24 without any contradiction as the ARP request given from the second virtual machine.

Then, the IP layer 24 generates an ARP reply in response to the ARP request. The ARP reply is defined as the packet addressed to the second virtual machine and is therefore matched with the pre-translation setting depicted in FIG. 14.

Accordingly, the destination IP address of the ARP reply is “10.20.2.2” but does not exist within the self-device, and hence the IP layer 24 transfers the ARP reply to the driver unit 25B of the adaptor 17B belonging to the same IP subnet as that of the destination IP address of the ARP reply.

The driver unit 25B or the adaptor 17B translates the address of the ARP reply so as to match with the post-translation setting depicted in FIG. 14 and transmits this ARP reply to the adaptor 17A set as destination of the post-translation reply.

The ARP reply is received by the other adaptor 17A via the cable and transmitted to the driver unit 25A and the IP layer 24 in sequence.

The ARP reply is, if the source is the first virtual machine depicted in FIG. 3 and the destination is the adaptor 17A, translated in the same way as the ARP reply sent back from the first virtual machine is translated. Accordingly, even the ARP reply transmitted from the adaptor 17B is received in the sequence such as the adaptor 17A→the driver unit 25A→the IP layer 24 without any contradiction as the ARP reply given from the first virtual machine.

Hence, the IP layer 24 interprets that the source MAC address associated with the source IP address=10.20.1.2 is “MAC12”, thus normally finishing the address resolution.

After the address resolution, the IP layer 24 transfers the TCP/IP packet matched with the pre-translation setting in FIG. 15 to the driver unit 25A, and driver unit 25A or the adaptor 17A translates (the address of) the TCP/IP packet as in the post-translation setting depicted in FIG. 15 and transmits this TCP/IP packet to the adaptor 17B.

The TCP/IP packet is received as the TCP/IP packet coming from the second virtual machine by the adaptor 17B via the cable.

Thus, each adaptor 17A is made to appear as if being the second virtual machine to the adaptor 17B, thereby performing the communications between the adaptors 17A, 17B.

Further, in the example given above, the packet is transmitted from the adaptor 17A to the adaptor 17B but can be similarly transmitted from the adaptor 17B to the adaptor 17A. For example, in the case of executing the command by specifying the address of the second virtual machine such as “netperf -H 10.20.2.2 . . . ”, the operation is conducted in a status of replacing the driver unit 25A and the adaptor 17A with the driver unit 25B and the adaptor 17B as compared with the status described above. Namely, the communications between the adaptors 17A, 17B are performed by replacing the translation process in FIGS. 13-15 with the translation process in FIGS. 16-18.

Herein, in the case of executing the “netserver” command, the following option may be designated.

>netserver -p 5000

Side note 1: The “-p” option involves designating a TCP port number.

Further, in the case of executing the “netperf” command, the following option may be designated.

>netperf -H 10.20.1.2 -1 10 -p 5000 -s 65536

Side note 1: The “-H” option involves designating the destination IP address.

Side note 2: The “-1” option involves designating a period of measuring time. The “netperf” command return after an elapse of this period of time. In this case, it is 10 sec.

Side note 3: The “-p” option involves designating the same TCP port number as the port number designated in the “netserver” command. In this case, the TCP port number is “5000”.

Side note 4: The “-s” option implies a TCP window size, however, a data size of the data transferred to a “send( )” function takes this value, which designates a packet size of the packet to be transmitted.

The application unit 21, upon establishing the TCP connection between the adaptors 17A, 17B by executing the “netperf” command, continues to transmit the data to the IP address designated in the “-H” option at the highest possible speed. Specifically, the application unit 21 continues to request to transmit the data by using Socket function “send( )” (S2 in FIG. 4).

Further, the application unit 21 continues to receive the data with a Socket function “recv( )” by executing the “netserver” Daemon.

Note that in the case of transmitting the data to the greatest possible degree, if the CPU 12 has a comparatively low processing speed, a data transmission speed depends, it is also considered, on a throughput of the CPU 12. A normal throughput of the CPU 12 is well higher than the transmission speed of the network adaptor. For instance, any trouble does not occur in the measurement even when starting up a plurality of performance measuring tools simultaneously or bidirectionally.

To be specific, when the transmission queue 71 of the adaptor 17A illustrated in FIG. 27 comes to have no free space, as described above, the driver unit 25A, instead of making the transmission request to the adaptor 17A, accumulates the transmission packets in the transmission queue 61 of the driver unit 25A.

Then, when the transmission queue 61 of the driver unit 25A has no free space, it follows that the transmission packets are accumulated in the transmission queue of the IP layer.

Then, further, when the transmission queue of the IP layer has likewise no free space, the “send( )” function does not return during a period till the transmission queue comes to have the free space, namely, there occurs a returning delay of the “send( )” function.

Moreover, the TCP layer of the computer 1 checks whether the transmitted data reaches the communication target device or not. Namely, if a TCP ACK packet (data reception acknowledgment packet) is not sent back from the communication partner device after an elapse of a fixed period of time or after transmitting a fixed q quantity of data, the TCP layer determines that the transmission data does not arrive at the communication target device and suspends the next transmission or executes a retransmission process.

The application unit 21 observes this phenomenon as the returning delay of the “send( )” function.

When reaching the time designated in the “-1” option related to the “netperf” command, the application unit 21 terminates the data transmission, then the test result calculating unit 26 calculates a performance value from the quantity of transmitted-data and the period of time (10 sec in this case) (S7), and the test result output unit 27 outputs a test result (S8).

For example, the performance value is displayed as below. In this case, it proves that the throughput is on the order of 782.52 Mbps when tested for 10 sec, in which a Socket size is 65536 bytes and a transmission message size is 65536 bytes.
TCP Stream Test
Recv Send Send
Socket Socket Message Elapsed
Size Size Size Time Throughput
bytes bytes bytes secs. 10̂6 bits/sec
65536 65536 65536 10.00 782.52

As described above, according to the first embodiment, the TCP/IP-based communications can be performed between the network adaptors 17A, 17B mounted in one single testing device 1, and hence the network adaptors 17A, 17B or the network drivers can be tested with the simple configuration.

Note that the network driver may also be, without being limited to the adaptor separate from the testing device 1 such as the network card inserted into an extension slot, built in the testing device 1, for example, implemented in a motherboard. According to the first embodiment, it is feasible to provide a technology by which one testing device tests the network adaptor or the network driver.

### Second Embodiment

—Case of Inserting One Card into Single Testing Device 1—

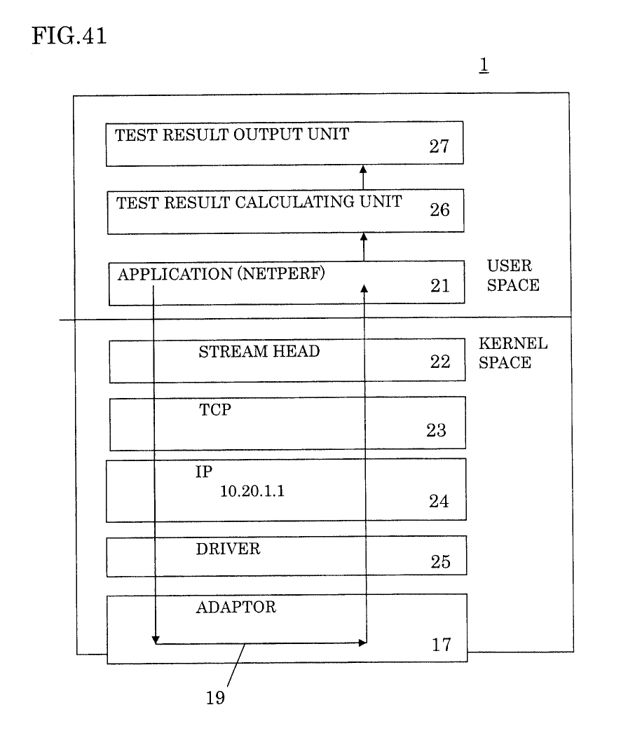

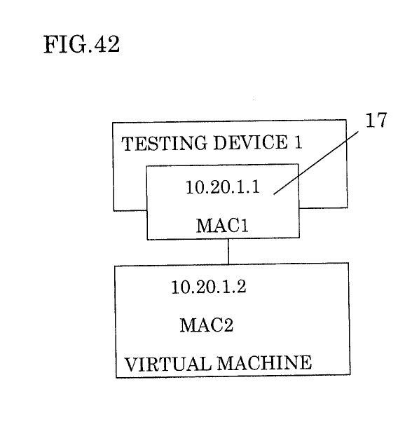

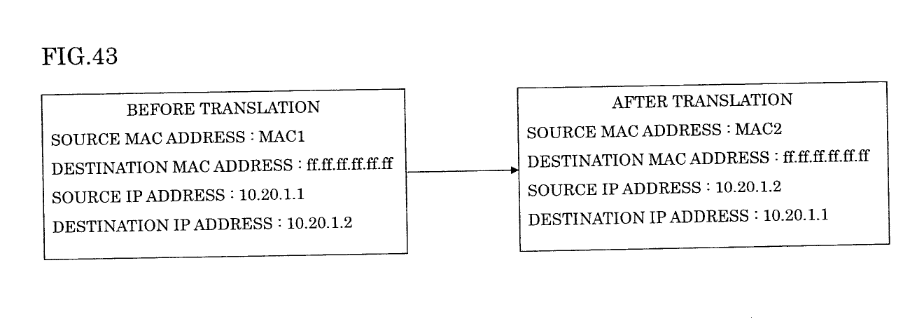

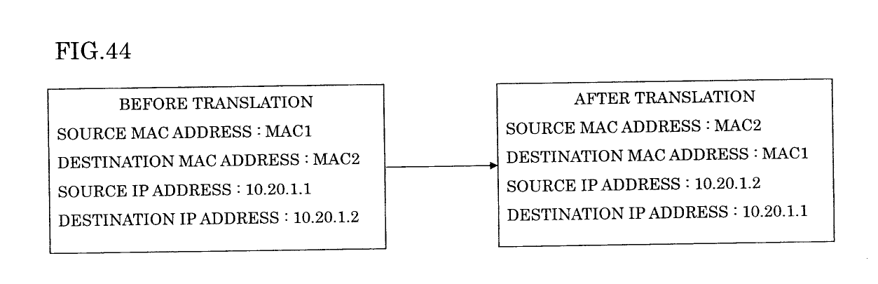

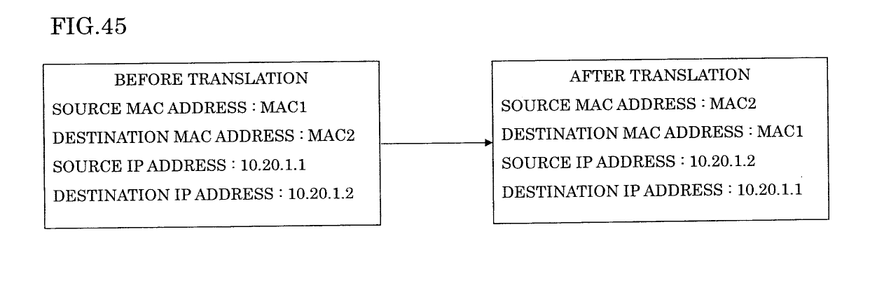

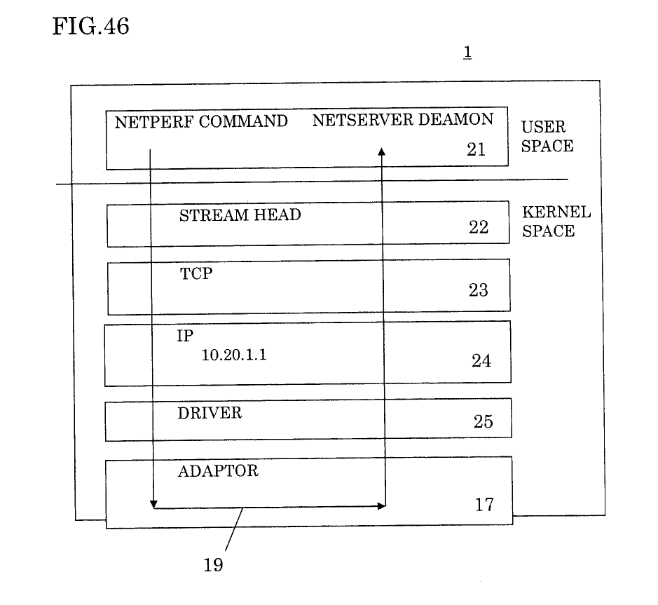

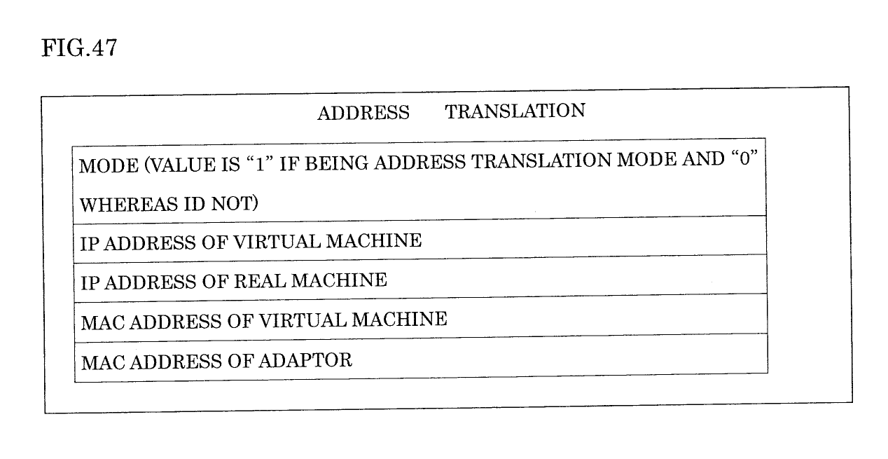

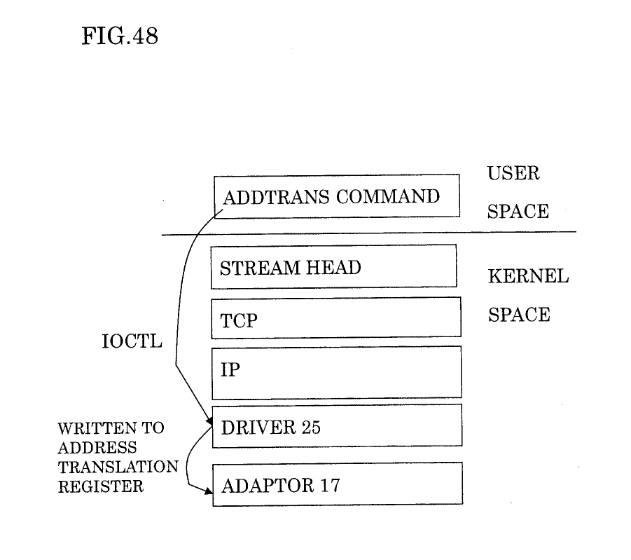

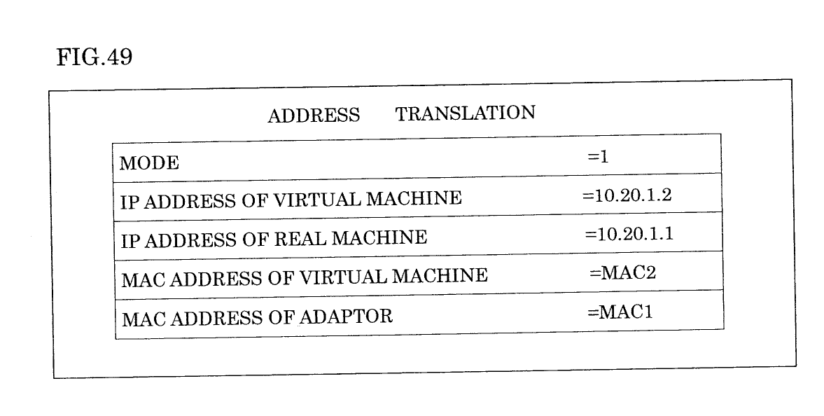

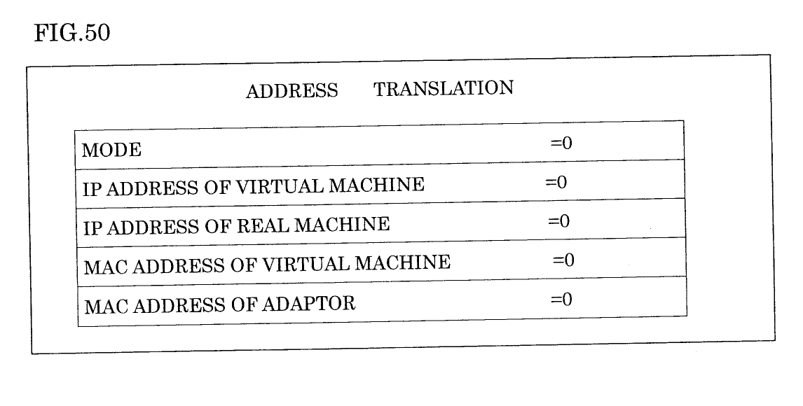

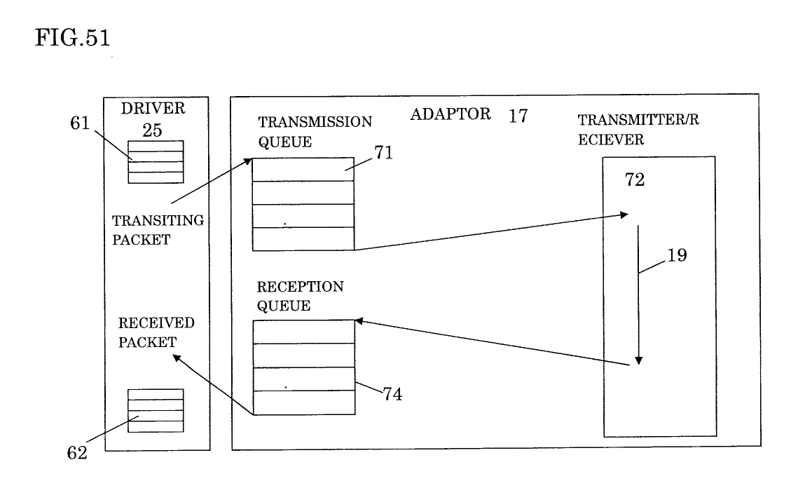

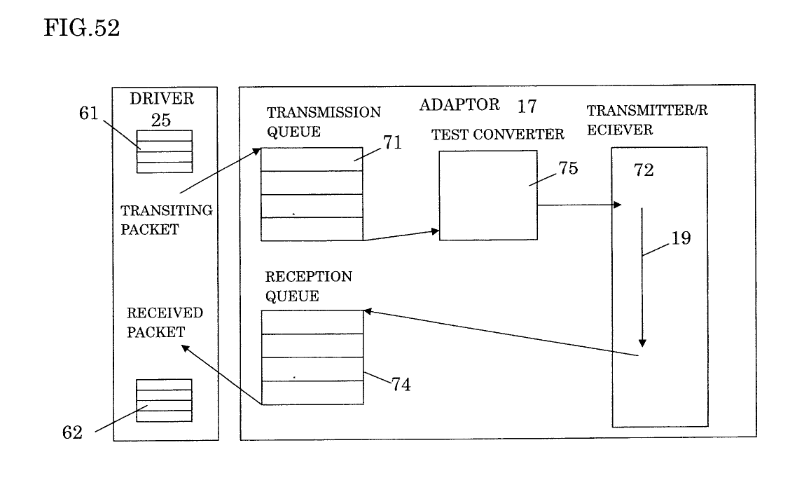

FIG. 41 is a diagram illustrating the computer 1 in a second embodiment; FIG. 42 is a conceptual diagram of a testing method in the second embodiment; FIG. 43 is a diagram depicting an example of how the address is translated; FIG. 44 is a diagram depicting an example of how the address is translated; FIG. 45 is a diagram depicting an example of how the address is translated; FIG. 46 is a diagram illustrating a transmission route when in the test mode; FIG. 47 is an explanatory diagram of the address translation register; FIG. 48 is an explanatory diagram of a process of updating the address translation register; FIG. 49 is a diagram illustrating one example of a value written to the address translation register; FIG. 50 is an example of setting the normal mode by clearing the value in the address translation register; FIG. 51 is a function block diagram of the adaptor when in the normal mode; and FIG. 52 is a function block diagram of the adaptor when in the test mode.

The second embodiment is different from the first embodiment in terms of a point of taking one network card (adaptor) 17 that is mounted in the testing device 1 in FIGS. 1 and 2. Other configurations are the same as in the first embodiment, and hence the repetitive explanation is omitted by marking the same components with the same reference numerals and symbols.

The adaptor 17 has an intra-adaptor loopback function of receiving the data by itself, which is transmitted toward the network side, as the data coming from the network side. For example, the adaptor 17 has a route 19 illustrated in FIG. 41 along which the data is detoured to the receiving side of the adaptor 17 itself from the transmitter/receiver 72 and from the transmitting side of the interface with the network.

In the second embodiment, as depicted in FIG. 42, the communications are performed in a way that makes the IP layer view as if the IP address of the adaptor 17 is “10.20.1.1” and the IP address of the virtual machine defined as the communication partner device is “10.20.1.2”.

The IP address of the virtual machine is selected from the addresses that do not exist on the testing device 1. This is because, if the IP address of the virtual machine is the address existing on the testing device 1, the packet loops back at the IP layer 24 when set as the destination address.

Further, the IP address belonging to the same IP subnet as the IP subnet of the adaptor 17 is allocated to the virtual machine so that the transmission to the virtual machine is performed by the adaptor 17.

The MAC address different from that the MAC address of the adaptor 17 is allocated to the virtual machine. Namely, the MAC address “MAC2” of the virtual machine is set different from the MAC address “MAC1” of the adaptor 17.

As described above, the scheme of making the IP layer view as if performing the communications with the virtual machine involves, in the second embodiment, adopting a testing method of performing the communications in such a way that the hardware (adaptor) or the driver (software) translates the IP address and the MAC address. In a flow of the testing method, as compared with FIG. 4, the data is transmitted and received by one adaptor, and hence the addresses to be translated get different as follows.

To be specific, the translation is carried out as below.

(1) The adaptor 17 or the driver unit 25, when transmitting an address resolution request (ARP request), as illustrated in FIG. 43, translates the destination IP address to “10.20.1.1” from “10.20.1.2” and changes the source IP address to “10.20.1.2” from “10.20.1.1”, and translates the source MAC address into “MAC2” from “MAC1”.

Specifically, at first, the application unit 21 sends, to the stream head 22, the data to be transmitted, of which the communication destination address is the IP address that does not exist within the self-device. With this operation, the IP layer 24 generates the address resolution request packet in the pre-translation setting in FIG. 43 (S101).

The destination IP address of the address resolution request packet does not exist within the self-device, and therefore the IP layer 24 sends the packet to the driver unit 25 belonging to the same IP subnet as that the IP subnet of the destination IP address of the address resolution request packet (S102).

The adaptor 17 or the driver unit 25 receiving the packet from the IP layer 24 determines whether the mode is the address translation mode (test mode) or not (S103), if determined to be the address translation mode, translates the address as in FIG. 43 (S104) and transmits the packet (S105). Note that whereas if not the address translation mode in S103, the packet is transmitted without translating the address (S106).

The address translation in S104 involves translating, as depicted in FIG. 43, the destination IP address and the destination MAC address so that the transmission destination is the adaptor 17 within the self-device. The example of FIG. 43, however, deals with the address resolution request packet, and hence the destination MAC address thereof is set to ff.ff.ff.ff.ff.ff for broadcasting.

The address translation in S104 further involves translating, as illustrated in FIG. 43, the source IP address and the source MAC address of the packet to be transmitted so that the transmission source thereof becomes the predetermined virtual machine. For example, for making the communication partner device appear to be the virtual machine as illustrated in FIG. 42, the packet is transmitted in a way that translates the source IP address into “10.20.1.2” and the source MAC address into “MAC2”.

The transmission packet is looped back at the adaptor 17 via a bypass 19 and then received. The adaptor 17 transmits the received packet to the application unit 21 via the driver unit 25, the IP layer 24, the TCP layer 23 and the stream head 22. Namely, the application unit 21 receives the packet, which is loopback-received by the adaptor 17, as the packet from the sender virtual machine.

(2) The adaptor 17 or the driver unit 25 translates, when transmitting the address resolution reply (ARP reply), as depicted in FIG. 44, the destination IP address into “10.20.1.1” from “10.20.1.2”, the destination MAC address into “MAC1” from “MAC2”, the source IP address into “10.20.1.2” from “10.20.1.1” and source MAC address into “MAC2” from “MAC1”.

Namely, the application unit 21 sends the address resolution reply back to the virtual machine (S201).

In this case also, as in the pre-translation setting illustrated in FIG. 44, the destination IP address does not exist within the self-device, and hence the IP layer 24 transmits the packet to the driver unit 25 belonging to the same IP subnet (S202).

The adaptor 17 or the driver unit 25 receiving the packet determines whether the mode is the address translation mode (test mode) or not (S203), if determined to be the address translation mode, translates the address as in FIG. 44 (S204) and transmits the packet (S205). Note that whereas if not the address translation mode in S203, the packet is transmitted without translating the address (S206).

The address translation in S204 involves translating the destination IP address and the destination MAC address as in FIG. 44 so that the transmission destination becomes the adaptor 17 within the self-device.

Moreover, the address translation in S204 involves translating the source IP address and the source MAC address as in FIG. 44 so that the transmission source becomes the predetermined virtual machine. As depicted in FIG. 42, in order to make the communication partner device appear to be the virtual machine, the source IP address is set to “10.20.1.2”, and the source MAC address is set to “MAC2”.

The transmission packet is received by the adaptor 17 via the bypass 19. The adaptor 17 transmits the received packet to the application unit 21 via the driver unit 25, the IP layer 24, the TCP layer 23 and the stream head 22. Namely, the application unit 21 receives the packet as from the sender virtual machine.

(3) The adaptor 17 or the driver unit 25 translates, when transmitting the TCP/IP packet, as depicted in FIG. 45, the destination IP address into “10.20.1.1” from “10.20.1.2”, the destination MAC address into “MAC1” from “MAC2”, the source IP address into “10.20.1.2” from “10.20.1.1” and source MAC address into “MAC2” from “MAC1”.

The application unit 21, which recognizes the MAC address of the virtual machine owing to the address resolution, sends the packet addressed to the virtual machine (S301).

As in the pre-translation setting in FIG. 45, the destination IP address of the packet transmitted by the application unit 21 does not exist within the self-device, and hence the IP layer 24 transmits the packet to the driver unit 25 belonging to the same IP subnet as that of the destination IP address (S302).

The adaptor 17 or the driver unit 25 receiving the packet determines whether the mode is the address translation mode (test mode) or not (S303), if determined to be the address translation mode, translates the address as in FIG. 45 (S304) and transmits the packet (S305). Note that whereas if not the address translation mode in S303, the packet is transmitted without translating the address (S306).

The address translation in S304 involves translating the destination IP address and the destination MAC address as in FIG. 45 so that the transmission destination becomes the adaptor 17 within the self-device.

Further, the address translation in S304 involves translating the source IP address and the source MAC address as in FIG. 45 so that the transmission source becomes the predetermined virtual machine. As depicted in FIG. 42, in order to make the communication partner device appear to be the virtual machine, the source IP address is set to “10.20.1.2”, and the source MAC address is set to “MAC2”.

The transmission packet is received by the adaptor 17 via the bypass 19. The adaptor 17 transmits the received packet to the application unit 21 via the driver unit 25, the IP layer 24, the TCP layer 23 and the stream head 22. Namely, the application unit 21 receives the packet as from the sender virtual machine.

—User Interface—

The transition to the address translation mode, namely, the test mode and the cancellation of the mode are designated by the user in a way that uses the commands.

An assumption is herein that the testing device 1 is in a status of FIG. 41, namely, a status in which the single testing device 1 is mounted with one adaptor 17, and the driver unit 25 is associated with the IP address “IP1.10.20.1.1”.

In this case, the transition to the address translation mode is designated by the user from the input unit 15 as below.

>addrtrans1 -s driver#1 10.20.1.2

Herein, “driver#1” is a driver name of the driver unit 25, and “10.20.1.2” is the IP address of the virtual machine.

The cancellation of the address translation mode is designated as follows.

>addrtrans1 -d driver#1

After transitioning to the address translation mode and when transmitting the packet while designating the IP address (IP2=10.20.1.2) of the virtual machine as the destination address, as illustrated in FIG. 46, it is feasible to execute the transmission via the “netperf” command 21→the stream head 22→TCP layer 23→the IP layer 24→the driver unit 25 the adaptor 17→the driver unit 25→the IP layer 24→the TCP layer 23→the stream head 22→the “netserve” Daemon 21.

For instance, after transitioning to the address translation mode, the command is executed as below.

>netperf -H 10.20.1.2

—Implementation of Command in the Case of Translating Address by Adaptor—

The adaptor 17 ensures the address translation register depicted in FIG. 47 in a predetermined area of the memory space.

The address translation register in FIG. 47 store the items such as the present mode, the IP address of the virtual machine, the IP address of the real machine, the MAC address of the virtual machine and the MAC address of the adaptor. Note that the present mode is set to “1” in the case of the address translation mode and “0” in the case of the normal mode. The IP address of the real machine is defined as the IP address of the driver unit 25 or the adaptor 17.

Then, in the case of executing the “addrtrans1 -s” command, the CPU 12 is to perform the following operations.

To begin with, the MAC address and the IP address of the adaptor 17 are searched through the existing interface provided in the OS. Note that the MAC address and the IP address are stored in the memory according to the OS in the way of being associated with the driver name related to the adaptor 17.

Next, the MAC address is allocated to the virtual machine. A value of the MAC address is “MAC2”. Herein, unique values are allocated respectively to the MAC address “MAC2” of the virtual machine and the MAC address “MAC1” of the adaptor 17.

The IP address of the virtual machine is given as an argument of the “addrtrans1” command, and therefore it follows that there are prepared all of the values to be written to the address translation register.

Next, the application unit 21 transfers to the driver unit 25, based on “ioctl” as illustrated in FIG. 48, the MAC address and the IP address of the adaptor 17 and the MAC address of the virtual machine as the values to be written to the address translation register of the adaptor 17.

The driver unit 25, upon receiving the ioctl-based values, writes these values to the respective fields of the MAC address of the adaptor in the address translation register of the adaptor, the IP address of the real machine and the MAC address of the virtual machine.

For instance, in the case of executing “addrtransl -s driver#1 10.20.1.2”, the values are, as illustrated in FIG. 49, written to the address translation register of the adaptor 17 from the driver unit 25.

Specifically, the value of the mode is “1”, the IP address value of the virtual machine is “10.20.1.2”, the IP address value of the real machine is “10.20.1.1”, the MAC address value of the virtual machine is “MAC2”, and the MAC address value of the adaptor is “MAC1”.

Then, in the case of executing “addrtrans1 -d driver#1” and canceling the address translation mode, the driver unit 25 clears, as depicted in FIG. 50, the whole values of the adaptor 17 down to “0”.

—Implementation of Command in the Case of Translating Address by Driver—

The driver unit 25 retains the data structure called the “control structure” in the memory 13 of the testing device in order to save the status of the adaptor and the information indicated from the high-order element.

The information equal to the information in the address translation register in FIG. 47 is taken into this control structure. This is called “address translation information”.

The process of transferring the values to be written to the address translation information to the driver unit 25 according to “ioctl” is the same as the process of transferring the values to be written to the address translation register in FIG. 48 description detail of the process of writing the address translation information will hereinafter be made.

The driver unit 25, upon receiving “ioctl”, updates the values of the control structure. For example, in the case of executing “addrtrans1 -s driver#1 10.20.1.2”, the driver unit 25 writes the values in FIG. 49 as the address translation information of the control structure.

On the other hand, in the case of executing “addrtrans1 -d driver#1” and canceling the address translation mode, as illustrated in FIG. 50, the driver unit 25 clears the address translation information of the control structure.

—Example of Implementation of Adaptor in the Case of Translating Address by Adaptor—

FIG. 51 is a function block diagram of the adaptor 17, depicting a status of when setting the normal mode, namely, a status of the case of performing the normal communications. As illustrated in FIG. 51, the adaptor 17 includes the transmission queue 71, the transmitter/receiver 72, and the reception queue 74.

On the other hand, FIG. 52 is a function block diagram of the adaptor 17, depicting a state of the case of carrying out the address translation.

When in the test mode, namely, in the case of performing the communications while translating the address, the second embodiment involves, as illustrated in FIG. 52, translating the address between the transmission queue 71 and the transmitter/receiver 72 by use of the test converter 75.

In the second embodiment, the operations of the respective components of the adaptor 17 are substantially the same as those given in FIGS. 28 and 29 in the first embodiment discussed above. For example, in FIGS. 28 and 29, the packet is transmitted from one adaptor 17A and received by the other adaptor 17B via the cable in the first embodiment. By contrast, in the second embodiment, the packet transmitted from the adaptor 17 is received by the adaptor 17 itself via the bypass 19, thereby enabling, though the addresses to be translated are simply different, the test converter 75 and the transmitter/receiver 72 to execute the transmitting process and the receiving process with the same logic.

As discussed above, according to the second embodiment, the TCP/IP-based communications can be performed in a way that loops back within one network adaptor 17 mounted in the testing device 1, and hence the network adaptor or driver can be tested with the simple configuration.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A testing device connected to at least one network adaptor, comprising:
a transmission application unit to give an instruction of transmitting data to a virtual address defined as a destination address;
an address translation unit to translate, if a test mode is set up, the destination address of the data into an address allocated to the network adaptor connected to the testing device, send the data to the network adaptor or another network adaptor connected to said the testing device and get the network adaptor or the another network adaptor to transmit the data;
a reception application unit to receive the data via the network adaptor to which the translated destination address is allocated; and
a calculation unit to calculate a test result based on a transmission result of the data.

2. The testing device according to claim 1, wherein the address translation unit translates, in the case of the test mode, a source address of the data into a virtual address.

3. The testing device according to claim 1, further comprising a packet generating unit to generate a packet with the destination address attached to the data according to an Internet protocol.

4. The testing device according to claim 1, wherein the network adaptor has a function of looping back the transmission data within the network adaptor and receiving the data, and, in the case of the test mode, the one network adaptor transmits and receives the data of which destination address is translated.

5. The testing device according to claim 1, wherein a first network adaptor and a second network adaptor are connected to the testing device, and the data is transmitted from the first network adaptor and received by the second network adaptor via the network cable, in which case the address translation unit translates the destination address of the data into the address allocated to the second network adaptor.

6. A testing method by which a testing device connected to at least one network adaptor, executes:
giving an instruction of transmitting data to a virtual address defined as a destination address;
translating, in the case of a test mode, the destination address of the data into an address allocated to the network adaptor connected to the testing device, sending the data to the network adaptor or another network adaptor connected to said the testing device and getting the network adaptor or the another network adaptor to transmit the data;
receiving the data via the network adaptor to which the translated destination address is allocated; and
calculating a test result based on a transmission result of the data.

7. The testing method according to claim 6, wherein the source address of the data is translated into a virtual address in the case of the test mode.

8. The testing method according to claim 6, further comprising generating a packet with the destination address attached to the data is generated according to an Internet protocol.

9. The testing method according to claim 6, wherein the network adaptor has a function of looping back the transmission data within the network adaptor and receiving the data, and, in the case of the test mode, the one network adaptor transmits and receives the data of which destination address is translated.

10. The testing method according to claim 6, wherein a first network adaptor and a second network adaptor are connected to the testing device, and the data is transmitted from the first network adaptor and received by the second network adaptor via the network cable, in which case the destination address of the data is translated into the address allocated to the second network adaptor.

11. A computer readable non-transitory recording medium recorded with a program to make a testing device connected to at least one network adaptor, execute:
giving an instruction of transmitting data to a virtual address defined as a destination address;
translating, in the case of a test mode, the destination address of the data into an address allocated to the network adaptor connected to the testing device, sending the data to the network adaptor or another network adaptor connected to the testing device self-device and getting the network adaptor or the another network adaptor to transmit the data;
receiving the data via the network adaptor to which the translated destination address is allocated; and
calculating a test result based on a transmission result of the data.

12. The computer readable non-transitory recording medium recorded with a program according to claim 11, wherein the source address of the data is translated into a virtual address in the case of the test mode.

13. The computer readable non-transitory recording medium recorded with a program according to claim 11, wherein the program further making the testing device execute generating a packet with the destination address attached to the data according to an Internet protocol.

14. The computer readable non-transitory recording medium recorded with a program according to claim 11, wherein the network adaptor has a function of looping back the transmission data within the network adaptor and receiving the data, and, in the case of the test mode, the one network adaptor transmits and receives the data of which destination address is translated.

15. The computer readable non-transitory recording medium recorded with a program according to claim 11, wherein a first network adaptor and a second network adaptor are connected to the testing device, and the data is transmitted from the first network adaptor and received by the second network adaptor via the network cable, in which case the destination address of the data is translated into the address allocated to the second network adaptor.
